(19) United States
(12) Patent Application Publication
(10) Pub. No.: US 2023/0014904 A1
(43) Pub. Date: Jan. 19, 2023

(54) SEARCHABLE DATA STRUCTURE FOR ELECTRONIC DOCUMENTS

(71) Applicant: SparkCognition, Inc., Austin, TX (US)

(72) Inventors: Erik Skiles, Manor, TX (US); Sandeep Gunda, Austin, TX (US); William McNeill, Austin, TX (US)

(21) Appl. No.: 17/812,597

(22) Filed: Jul. 14, 2022

Related U.S. Application Data
(60) Provisional application No. 63/222,742, filed on Jul. 16, 2021.

(51) Int. Cl. G06F 16/901; G06F 16/906; G06F 16/93; G06F 40/279

(52) U.S. Cl. CPC G06F 16/9027; G06F 16/906; G06F 16/93; G06F 40/279

(57) ABSTRACT

A method of generating a searchable representation of an electronic document includes obtaining an electronic document specifying a graphical layout of content items. The content items include at least text in a table. The method also includes selecting masking rules, generating a vertical mask based on the masking rules, and generating a horizontal mask based on the masking rules. The vertical mask indicates estimated locations of vertical boundaries of table columns of the table, and the horizontal mask indicates estimated locations of horizontal boundaries of table rows of the table. The method also includes identifying cells of the table based on the vertical mask and the horizontal mask and generating a searchable data structure based on text corresponding to the identified cells of the table.

### CROSS-REFERENCE TO RELATED APPLICATIONS

The present application claims priority from U.S. Provisional Patent Application No. 63/222,742 filed Jul. 16, 2021, entitled “SEARCHABLE DATA STRUCTURE FOR ELECTRONIC DOCUMENTS,” which is incorporated by reference herein in its entirety.

### BACKGROUND

The increased use of computer systems and electronic communications has resulted in generation of and exchange of a large quantity of electronic documents. It is not uncommon for individuals and organizations to have access to so many electronic documents that the sheer quantity of information available can hamper efforts to retrieve specific information when it is desired.

Generally, document archives are searched using keywords. In some situations, keyword searches are not particularly well matched to the way people recognize and search for information. For example, keyword searches seek to match specific text within the electronic document. In contrast, humans extract a great deal of information from the format, layout, and context of the electronic document.

### SUMMARY

To improve information retrieval, disclosed systems and methods generate searchable data structures to facilitate searching for information in a corpus of electronic documents. The searchable data structures are generated in a manner that captures text of the electronic documents and also captures context information based on a graphical layout of the electronic documents.

The searchable data structures have a smaller in-memory footprint than the corpus of electronic documents. Additionally, the searchable data structures facilitate information retrieval when the corpus of electronic documents includes structured or semi-structured content, such as tables. For example, it is common for businesses to periodically generate or updates certain business reports. For a particular company, a report during one period may have a similar, but not identical, format to the same report during a different period (e.g., due to changes in the business or operating environment). The searchable data structures facilitate searching such structured or semi-structured electronic documents by hierarchically arranging data in a manner that enables use of path-based searches to retrieve information from different reports. Additionally, a search engine associated with the searchable data structures can use the hierarchical arrangement of the searchable data structures to generate search heuristics that reduce search time, retrieve more relevant information, or both.

A particular aspect of the disclosure describes a method of generating a searchable representation of an electronic document. The method includes obtaining an electronic document specifying a graphical layout of content items, where the content items include at least text. The method also includes determining pixel data representing the graphical layout of the content items and providing input data based, at least in part, on the pixel data to a document parsing model. The document parsing model is trained to detect functional regions within the graphical layout based on the input data, assign boundaries to the functional regions based on the input data, and assign a category label to each functional region that is detected. The method also includes matching portions of the text to corresponding functional regions based on the boundaries assigned to the functional regions and locations associated with the portions of the text. The method further includes storing data representing the content items, the functional regions, and the category labels in a searchable data structure.

Another particular aspect of the disclosure describes a system including a memory storing instructions and a processor configured to execute the instructions to perform operations. The operations include obtaining an electronic document that includes data specifying a graphical layout of content items, where the content items include at least text. The operations also include determining pixel data representing the graphical layout of the content items and providing input data based, at least in part, on the pixel data to a document parsing model. The document parsing model is trained to detect functional regions within the graphical layout based on the input data, assign boundaries to the functional regions based on the input data, and assign a category label to each functional region that is detected. The operations also include matching portions of the text to corresponding functional regions based on the boundaries assigned to the functional regions and locations associated with the text. The operations further include storing a searchable data structure representing the content items, the functional regions, and the category labels.

Another particular aspect of the disclosure describes a non-transitory computer-readable medium storing instructions that are executable by a processor to cause the processor to perform operations. The operations include obtaining an electronic document that includes data specifying a graphical layout of content items, where the content items include at least text. The operations also include determining pixel data representing the graphical layout of the content items and providing input data based, at least in part, on the pixel data to a document parsing model. The document parsing model is trained to detect functional regions within the graphical layout based on the input data, assign boundaries to the functional regions based on the input data, and assign a category label to each functional region that is detected. The operations also include matching portions of the text to corresponding functional regions based on the boundaries assigned to the functional regions and locations associated with the text. The operations also include storing a searchable data structure representing the content items, the functional regions, and the category labels.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a block diagram of an example of a system configured to generate a searchable data structure based on one or more electronic documents.

FIG. 2 is a diagram illustrating aspects of generation of a searchable data structure based on one or more electronic documents according to a particular implementation of FIG. 1.

FIG. 3 is a diagram illustrating aspects of generation of a searchable data structure based on one or more electronic documents according to a particular implementation of FIG. 1.

FIG. 4 is a diagram illustrating aspects of generation of a searchable data structure based on one or more electronic documents according to a particular implementation of FIG. 1.

FIG. 5 is a diagram illustrating at least a portion of a searchable data structure according to a particular implementation of FIG. 1.

FIG. 6 is a diagram illustrating at least a portion of a searchable data structure according to a particular implementation of FIG. 1.

FIG. 7 is a diagram illustrating aspects of generating a document parsing model usable by the system of FIG. 1.

FIG. 8 is a flow chart of an example of a method that can be initiated, controlled, or performed by the system of FIG. 1.

FIG. 9 is a flow chart of another example of a method that can be initiated, controlled, or performed by the system of FIG. 1.

FIG. 10A-10G depicts a particular illustrative example of generating a searchable representation of an electronic document.

FIG. 11 is an example of pseudocode of a layout generation algorithm described with respect to FIGS. 10A-10G.

FIG. 12 is a flow chart of another example of a method that can be initiated, controlled, or performed by the system of FIG. 1.

FIG. 13 is a diagram illustrating details of one example of automated model builder instructions to generate one or more of the machine-learning models of FIG. 1.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

Aspects disclosed herein relate to machine learning. As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

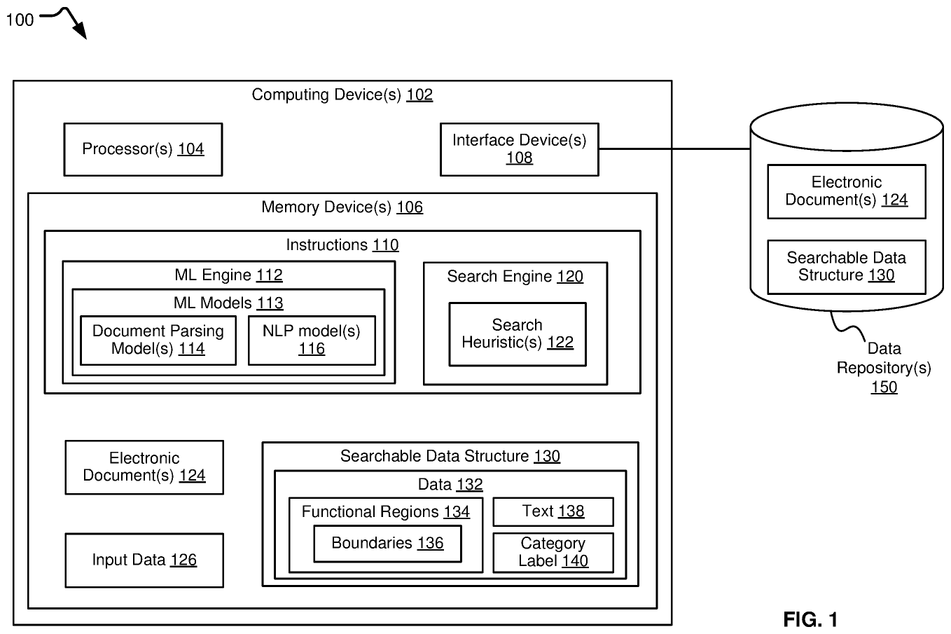

FIG. 1 is a block diagram of an example of a system 100 configured to use machine learning to generate a searchable data structure 130 based on one or more electronic documents 124. The searchable data structure 130 is configured to facilitate knowledge retrieval from the electronic documents 124. For example, the electronic documents 124 may include a combination of unstructured text (e.g., prose), structured text (e.g., tables), and other content (referred to herein as “semi-structured”) which is not clearly structured or unstructured (e.g., bullet point lists, tables that are not clearly delineated with gridlines, etc.). The system 100 is configured to generate the searchable data structure 130 such that information can be readily retrieved from any portion of the electronic documents, including unstructured text, structured text, and other content. One benefit of arranging information from the electronic documents 124 in the searchable data structure 130 is that search heuristics 122 can be generated to improve certain knowledge retrieval operations, as described further below.

The system 100 includes one or more computing devices 102. Each computing device 102 includes one or more processors 104, one or more interface devices 108, and one or more memory devices 106. In some examples, the computing device(s) 102 include one or more host computers, one or more servers, one or more workstations, one or more desktop computers, one or more laptop computers, one or more Internet of Things devices (e.g., a device with an embedded processing systems), one or more other computing devices, or combinations thereof.

The processor(s) 104 include one or more single-core or multi-core processing units, one or more digital signal processors (DSPs), one or more graphics processing units (GPUs), or any combination thereof. The processor(s) 104 are configured to access data and instructions 110 from the memory device(s) 106 and to perform various operations described further below. The processor(s) 104 are also coupled to the interface device(s) 108 to receive data from another device (such as receiving additional electronic documents 124 from a data repository 150), to send data to another device (such as sending a searchable data structure 130 or search query to the data repository 150 or sending a graphical user interface to a display device), or both.

The interface devices(s) 108 include one or more serial interfaces (e.g., universal serial bus (USB) interfaces or Ethernet interfaces), one or more parallel interfaces, one or more video or display adapters, one or more audio adapters, one or more other interfaces, or a combination thereof. The interface devices(s) 108 include a wired interface (e.g., Ethernet interfaces), a wireless interface, or both.

The memory device(s) 106 include tangible (i.e., non-transitory) computer-readable media, such as a magnetic or optical memory or a magnetic or optical disk/disc. For example, the memory device(s) 106 include volatile memory (e.g., volatile random access memory (RAM) devices), nonvolatile memory (e.g., read-only memory (ROM) devices, programmable read-only memory, or flash memory), one or more other memory devices, or a combination thereof.

The instructions 110 are executable by the processor(s) 104 to cause the processor(s) 104 to perform operations to generate the searchable data structure 130 based on the electronic document(s) 124, to retrieve data from the searchable data structure 130, or both. For example, in FIG. 1, the instructions 110 include a machine-learning (ML) engine 112 that is configured to execute one or more machine-learning models 113. The instructions 110 also include a search engine 120. In the example illustrated in FIG. 1, the machine-learning models 113 include one or more document parsing models 114 and one or more natural-language processing (NLP) models 116. In other examples, the machine-learning models 113 include additional models. Each of the machine-learning models 113 includes or corresponds to a trained model, such as a perceptron, a neural network, a support vector machine, a decision tree, a prototypical network for few-shot learning, an autoencoder, a random forest, a regression model, a Bayesian model, a naive Bayes model, a Boltzmann machine, deep belief networks, a convolutional neural network, another machine-learning model, or an ensemble, variant, or other combination thereof.

In some examples, the document parsing model(s) 114, the NLP model(s) 116, or both, includes two or more distinct models which cooperate to perform the operations described herein. For example, the document parsing model(s) 114 may include a first model that is trained to identify functional regions of an electronic document and a second model that is trained to identify subregions of a particular type of functional region. To illustrate, when the first model identifies a table in an electronic document 124, the second model may be used to identify parts of the table, such as rows, columns, data elements, headings, and so forth.

The memory device(s) 106, the data repository(s) 150, or both, store the electronic documents 124. Each electronic document 124 specifies a graphical layout of content items. The content items include, for example, text, graphics, pictures, etc. For certain types of electronic documents, such as portable document format (pdf) documents or image files (e.g., scanned documents), the content items and their graphical layout are represented by pixel data. In this context, “pixel data” refers to data that represents or specifies a plurality of display elements to render a display of the electronic document and each display element encodes at least one color bit representing a display color of the display element. As a simple example, the pixel data may include a set of data elements arranged such that each data element corresponds to a display pixel, and each data element includes a value of 1 to indicate that the corresponding pixel should be black or a value of 0 to indicate that the corresponding pixel should be white. Of course, many more complex representations of pixel data are commonly used, such as RGB data in which the color of each pixel is indicated by a red (R) value, a green (G) value, and a blue (B) value. Some pdf documents and many other types of documents also directly encode the text and graphical layout information. To illustrate, markup language documents, such as hypertext markup language (HTML) documents, may include text and as well as descriptors of layout information, such as font characteristics, spacing, colors, graphical elements (e.g., line, images, icons, etc.), and so forth.

The document parsing model(s) 114 are configured to receive input data 126 descriptive of one or more of the electronic document(s) 124 and to generate output data based on the input data 126. In a particular implementation, the document parsing model(s) 114 are trained to detect functional regions 134 within the graphical layout based on the input data 126, to assign boundaries 136 to the functional regions 134 based on the input data 126, and to assign a category label 140 to each functional region 134 that is detected. In this implementation, the output data from the document parsing model(s) 114 includes at least the category labels 140 and data descriptive of the boundaries 136 (e.g., pixel locations of corners or boundary regions). As used herein, a “functional region” refers to a portion of an electronic document that includes one or more content items and that is distinct from one or more other portions of the electric document in a manner that provides a contextual cue that the different portions include different types of content or are intended to convey different types of information. In particular implementations, the functional regions 134 are distinguished by context cues, such as text format (e.g., font size, font color, font position, other font characteristics, text alignment, or line spacing), position on a page, white space or blank regions on the page, background color, etc. To illustrate, one or more paragraphs of text with similar formatting may form a first functional region that is distinguished from a table by a changing in text format between text of the paragraphs and text of the table.

In some implementations, changes or differences in context cues between adjacent portions of the electronic document 124 indicate functional differences between the adjacent portions. To illustrate, a change in font characteristics, a change in character spacing, or a change in background color between two adjacent regions of the electronic document may indicate that the adjacent regions are distinct functional regions. Such differences can also be used to determine a category label associated with each of the adjacent functional regions. To illustrate, a first functional region, such as a paragraph of text, may have text of a first size, with first character spacing, first alignment, and first font characteristics (e.g., not bold); whereas an adjacent second functional region, such as a section heading, may have text of a second size, with second character spacing, second alignment, and/or second font characteristics (e.g., bold).

When certain functional regions 134 are identified in an electronic document 124, these functional regions 134 may be further processed to identify and label sub-regions. For example, an electronic document 124 may include a table (with or without gridlines), and the graphical layout of content within the table may be evaluated to identify table headings, column headings, row headings, columns, rows, data elements, or other features. In a particular implementation, sub-regions of a table may be identified using computer vision based processes, such as based on gridlines, a grid-like arrangement of text or other structural characteristics. Additionally, or alternatively, sub-regions of a table may be identified based on typographic characteristics or patterns of typographic characteristics, such as background color, text color, spacing (e.g., between characters, words, or lines), fonts, special characters (e.g., colons, slashes, commas, semicolons, dashes, or other text delimiters). Additionally, or alternatively, sub-regions of a table may be identified based on semantic characteristics of text of the table. For example, if several words on a page are approximately aligned vertically (e.g., along a length of the page), and the words belong to the same semantic group (e.g., each is the name of a food item), then the set of words may be identified as a column.

In some implementations, when a functional region 134 is labeled as a table, the document parsing model(s) 114 perform operations to process individual data elements, columns, or rows of the table. For example, for a particular functional region 134 labeled as a table, the document parsing model(s) 114 may estimate column boundaries and row boundaries based on the input data associated with the particular functional region. In this example, the document parsing model(s) 114 may also determine whether one or more columns of the table have a column heading. If a column has a column heading, the document parsing model(s) 114 determine text of the column heading based on the text associated within the particular functional region 134. The document parsing model(s) 114 store at least a portion of the text associated with the particular functional region in a first data element of the searchable data structure 130 and stores the column heading of the column in a second data element, where the first data element is subordinate to the second data element in the searchable data structure 130. To illustrate, the column heading may be stored in a branch node of a tree structure and text of a cell of the table that is in the column may be stored in a leaf node coupled to the branch node. In some implementations, the document parsing model(s) 114 identify a column heading based on output of the NLP model(s) 116. For example, some tables may not include explicit column headings. Rather, column headings may implied by the content of the cells of the column or other portions of the table (e.g., a table heading). To illustrate, a table listing expenses may include data such as “Rent”, “Payroll”, “Advertising”, “Taxes”, which, in context, a human reader would recognize as expense categories without an “Expense” heading being provided. To determine an implied column heading of a particular column, the NLP model(s) 116 may analyze text of the table, such as text of a table head, text in cells, etc., to identify a semantic group represented by text of the column. In such implementations, the semantic group is assigned as the column heading.

As described further below, in some implementations, the document parsing model(s) 114 are trained using a supervised learning technique. For example, a set of electronic documents in which various functional regions have been annotated are used as supervised training data to train the document parsing model(s) 114. The annotations associated with the set of electronic documents may indicate boundaries of the various functional regions and a category label associated with each. The category labels 140 indicate the function (e.g., the syntactical or structural purpose) of content within each functional region 134. Examples of category labels 140 include page headers, page footers, section headings, paragraphs, tables, images, footnotes, and lists.

The document parsing model(s) 114 designate the functional regions 134, assign category labels 140 to the functional regions 134, or both, based on a probabilistic analysis of the pixel data associated with the electronic document 124. In some implementations, the document parsing model(s) 114 may also apply one or more rules or heuristics to assign the category labels 140. For example, when the text 138 of a functional region 134 includes one or more special characters, the document parsing model(s) 114 may assign a particular category label 140 to the functional region 134 (or may perform operations to indicate an increased probability that the functional region 134 is associated with the particular category label 140). To illustrate, when the first character of each line of the text 138 of a functional region 134 includes a bullet point character, the document parsing model(s) 114 determine a high probability that the functional region 134 corresponds to a list. The high probability can be determined by assigning a default probability value (e.g., 1) or by weighting output of the probabilistic analysis of the document parsing model(s) 114 to increase the probability associated with the list category label. In some implementations, a rule can also, or in the alternative, be used to decrease the probability that a particular category label is assigned to a functional region 134. To illustrate, a rule may indicate that text 138 with a large font size (e.g., greater than an average font size for the electronic document), a bold font, and a centered alignment has a low probability of being assigned a footnote category label.

In some implementations, the document parsing model(s) 114 assign a category label 140 to a functional region 134 based in part on output from the NLP model(s) 116. For example, the NLP model(s) 116 can be executed to perform a semantic analysis of the text 138 of the functional region 134. In this example, the output of the NLP model(s) 116 may indicate that the text 138 of the functional region 134 includes a particular type of information, such as a citation, boilerplate language, a phone number, etc. In this example, the output of the NLP model(s) 116 is provided as input (along with other information) to the document parsing model(s) 114, and the document parsing model(s) 114 use the output of the NLP model(s) 116 to determine the category label 140 assigned to the functional region 134. To illustrate, a functional region 134 that includes a citation and is located at the bottom of a page may be assigned the category label footnote based on the semantic content of the functional region 134 and the graphical layout of the page.

After the document parsing model(s) 114 identify the functional regions 134 within a particular electronic document 124, the processor(s) 104 match portions of the text 138 of the particular electronic document 124 to corresponding functional regions 134 based on the boundaries 136 assigned to the functional regions 134 and locations associated with the text 138. To illustrate, text 138 of the electronic document 124 that is disposed (in the graphical layout) within boundaries 136 of a first functional region is assigned to the first functional region. Thus, each functional region 134 of an electronic document 124 is associated with text 138 (or other content items), boundaries 136, and a category label 140.

In some implementations, the processor(s) 104 determine a topology of the searchable data structure 130 based on the text 138 (or other content items), the boundaries 136, the category labels 140, or a combination thereof, associated with the functional regions 134. In this context, the “topology” of the searchable data structure 130 refers to the number, type, and arrangement of data elements (e.g., nodes) and interconnections between data elements. For example, in a particular implementation, the searchable data structure 130 has a hierarchical topology, such as a tree or graph structure, in which certain data elements are linked in an ordered arrangement with other data elements. In this example, the order of the hierarchy of the topology of the searchable data structure 130 is determined based on the arrangement of information in the electronic document(s) 124. As a particular example, the searchable data structure 130 may include a tree structure having a plurality of leaf nodes. In this example, each leaf node is associated with a corresponding branch node, and the content items of the electronic document(s) 124 are assigned to nodes of the tree structure such that a hierarchy of the functional regions 134 is represented in the tree structure. Thus, the searchable data structure 130 is a knowledge representation based on the electronic document(s) 124 rather than, for example, a template.

As one example, a structured electronic document 124 may include text 138 related to different topics. The various topics may be indicated by section headings, and a section heading may precede text associated with a particular topic indicated by the section heading. In this example, the topology of the searchable data structure 130 is determined based on which category labels 140 are assigned to the functional regions 134 of the electronic document 124 and the graphical layout of the functional regions 134. For example, if the document parsing model(s) 114 assign a section heading category label to a first functional region and assign a paragraph category label to a second functional region 134 that is adjacent to and following the first functional region, the topology of the searchable data structure 130 is arranged such that data associated with the first functional region is linked to and hierarchically superior to the data associated with the second function region.

The processor(s) 104 store data 132 of the searchable data structure 130 based on the content items (e.g., the text 138 or other content items), the functional regions 134, and the category labels 140. For example, after the topology of the searchable data structure 130 is determined, the functional regions 134 are identified, and the category labels 140 of the functional regions 134 are assigned, each functional region 134 can be mapped to one or more nodes (also referred to herein as data elements) of the searchable data structure 130. Contents items, such as text, images, graphics, etc., associated with a particular functional region are stored in the node of the searchable data structure 130 that is mapped to the particular functional region. The searchable data structure 130 thus encodes knowledge representation derived from the graphical layout of the electronic documents 124 without retaining the detailed graphical layout itself. As a result, the searchable data structure 130 has a smaller in-memory footprint than the electronic document 124 but retains information explicitly and implicitly represented in the electronic document 124.

In the example of FIG. 1, the system 100 also includes a search engine 120. The search engine 120 includes instructions that are executable by the processor(s) 104 to find and retrieve information from the searchable data structure 130 (or from the electronic document(s) 124 based on information within the searchable data structure 130). The search engine 120 is also configured to generate and/or use one or more search heuristics 122 to improve information retrieval. For example, the search heuristic(s) 122 may be used to augment a search query received from a user.

As one example, a business may periodically generate or receive documents that follow a similar graphical layout. To illustrate, an annual report to shareholders from a particular company may have a similar, but not necessarily identical, graphical layout from year to year. In a particular implementation, the search heuristic(s) 122 can describe a data path (e.g., a set of node and links, or key value pair(s)) indicating a path in the searchable data structure 130 to retrieve particular information for a particular type of electronic document.

The search heuristic(s) 122 are generated after the topology of the searchable data structure 130 is determined. For example, the one or more of the search heuristic(s) 122 may be generated responsive to an indication that data associated with a particular search (e.g., a set of search terms of a search query) was obtained from the searchable data structure 130 via a particular data path. In this example, information descriptive of at least a portion of the data path and information descriptive of the search query may be used to generate a rule that is added to the search heuristic(s) 122. In this example, the rule can be used to access similar data derived from other electronic documents. For example, a rule based on a query to identify Cost of Goods in the annual report for a first year can be used to identify Cost of Goods in annual reports for other years by searching the same data path in portions of the searchable data structure 130 associated with the other years.

The searchable data structure 130 has a smaller in-memory footprint than the electronic document(s) 124 it is based on. Additionally, the searchable data structure 130 facilitates information retrieval. For example, the searchable data structure 130 may store information from the electronic document(s) 124 in a hierarchical and/or interconnected manner that enables use of path-based searches to retrieve similar or related information from different electronic documents 124. In some implementations, the search engine 120 associated with the searchable data structure 130 can use the queries to the searchable data structure 130 to generate search heuristic(s) 122 that reduce search time, retrieve more relevant information, or both.

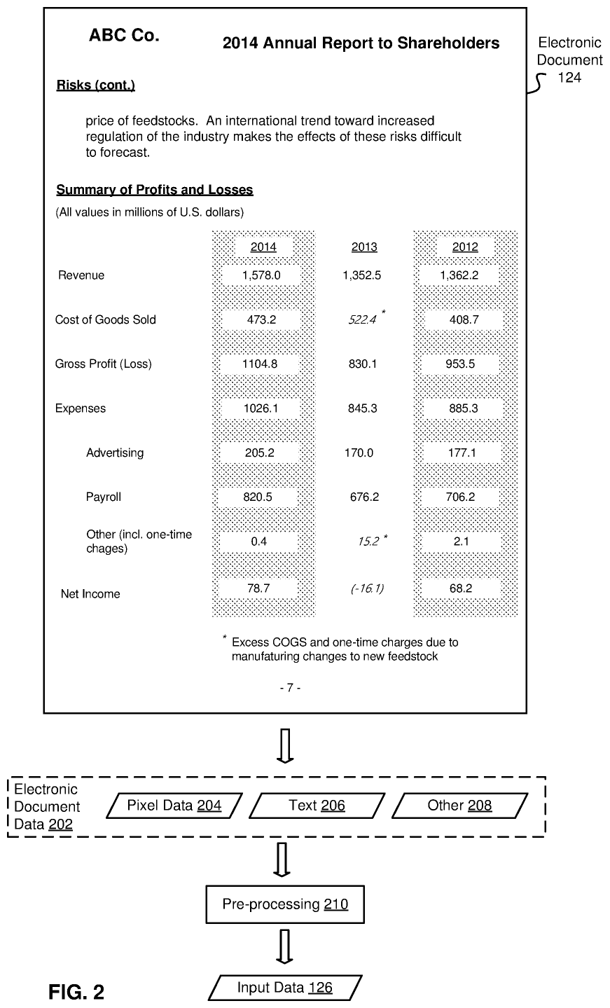

FIG. 2 is a diagram illustrating aspects of generation of the searchable data structure 130 based on one or more electronic documents 124 according to a particular implementation of the system 100 of FIG. 1. The operations described with reference to FIG. 2 may be performed by the processor(s) 104 of FIG. 1 executing instructions 110 from the memory device(s) 106.

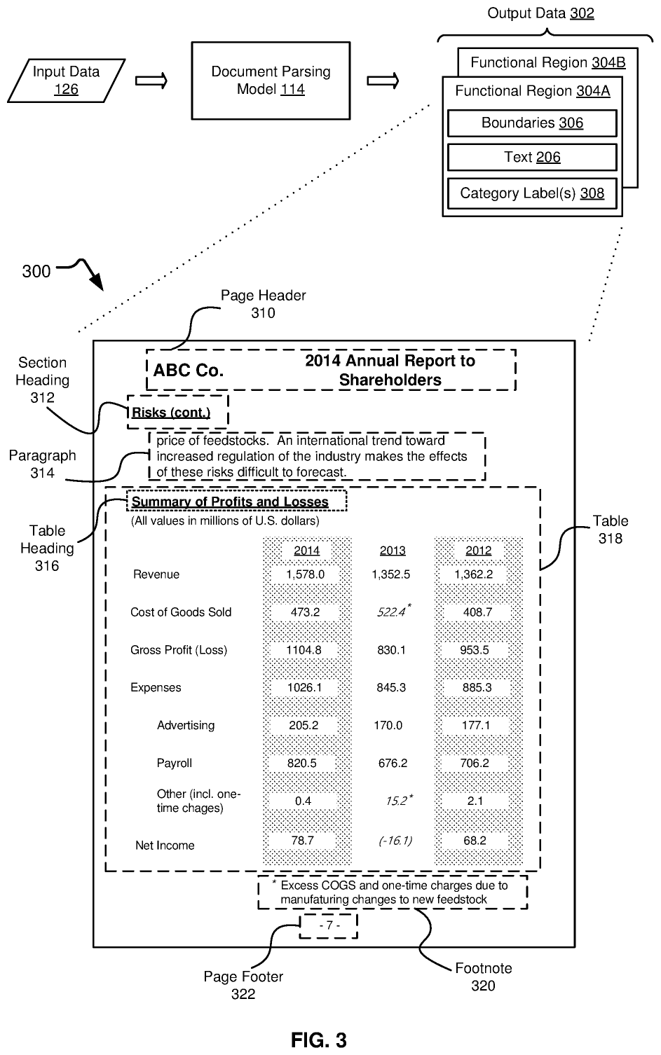

The diagram illustrated in FIG. 2 show one example of generating the input data 126 for the document parsing model(s) 114 of FIG. 1 based on an electronic document 124. For convenience of illustration, only a single page of one electronic document 124 is shown in FIG. 2; however, the electronic document(s) 124 may include more than one document and each document may include more than one page. Additionally, the electronic document 124 illustrated in FIG. 2 is formatted to include several examples of different types of functional regions, which are discussed further with reference to FIG. 3. Other pages of the electronic document 124 and other electronic documents may include more, fewer, or different types of functional regions. Further, FIG. 2 illustrates one example of how various functional regions may be distinguished in a graphical layout of content items. In other examples, the functional regions may be distinguished in other ways. To illustrate, the electronic documents 124 of FIG. 2 includes information arranged in a table that does not have gridlines; however, another page of the electronic document 124 or a different electronic document may include information arranged in a table that does have gridlines.

In FIG. 2, the electronic document 124 is stored as, includes, or is included within electronic document data 202. The electronic document data 202 includes pixel data 204, text 206, other data 208 (such as formatting information, file metadata, etc.), or a combination thereof. In some implementations, the text 206 is determined based on the pixel data 204, for example via an optical character recognition process. In other implementations, the other data 208 includes mark-up language information describing the graphical layout of the text 206 (and possibly other content items), and the pixel data 204 is determined based on the text 206 and the other data 208.

In the example illustrated in FIG. 2, the electronic document data 202 is provided to pre-processing instructions 210. In this example, the pre-processing instructions 210 are part of instructions 110 of FIG. 1. In some implementations, the machine-learning models 113 include the pre-processing instructions 210 (e.g., the pre-processing instructions 210 include or correspond to a trained model). In other implementations, the pre-processing instructions 210 are distinct from the machine-learning models 113.

The pre-processing instructions 210 generate the input data 126 based on the electronic document data 202. As one example, the pre-processing instructions 210 may generate the input data 126 as a vector of values encoding all of, or a portion of, the pixel data 204, the text 206, and the other data 208. To illustrate, the vector of values corresponding to the input data 126 may include or encode the pixel data 204 and the text 206. As another illustrative example, the vector of values corresponding to the input data 126 may include or encode the pixel data 204 and data representative of a portion of the text 206, the other data 208, or both. In this illustrative example, the data representative of a portion of the text 206, the other data 208, or both, may include n-grams or skip grams representing words, phrases, data values, or other information from the text 206, the other data 208, or both.

FIG. 3 is a diagram illustrating aspects of generation of the searchable data structure 130 based on the electronic document(s) 124 according to a particular implementation of the system 100 of FIG. 1. The diagram illustrated in FIG. 3 shows an example of output data 302 of the document parsing model(s) 114 including information identifying a plurality of functional regions 134 (such as a first functional region 304A and a second functional region 304B) of an electronic document 124 of FIGS. 1 and 2.

Although two functional regions 304A and 304B are illustrated in FIG. 3, the electronic document 124 may include more than two functional regions. For example, FIG. 3 includes a diagram 300 illustrating the example page of the electronic document 124 of FIG. 2 with various functional regions identified. In the diagram 300, each functional region is denoted by a dashed line indicating a boundary of the functional region. For example, in the diagram 300, the functional regions 134 include a page header 310, a section heading 312, a paragraph 314, a table 318, a footnote 320, and a page footer 322.

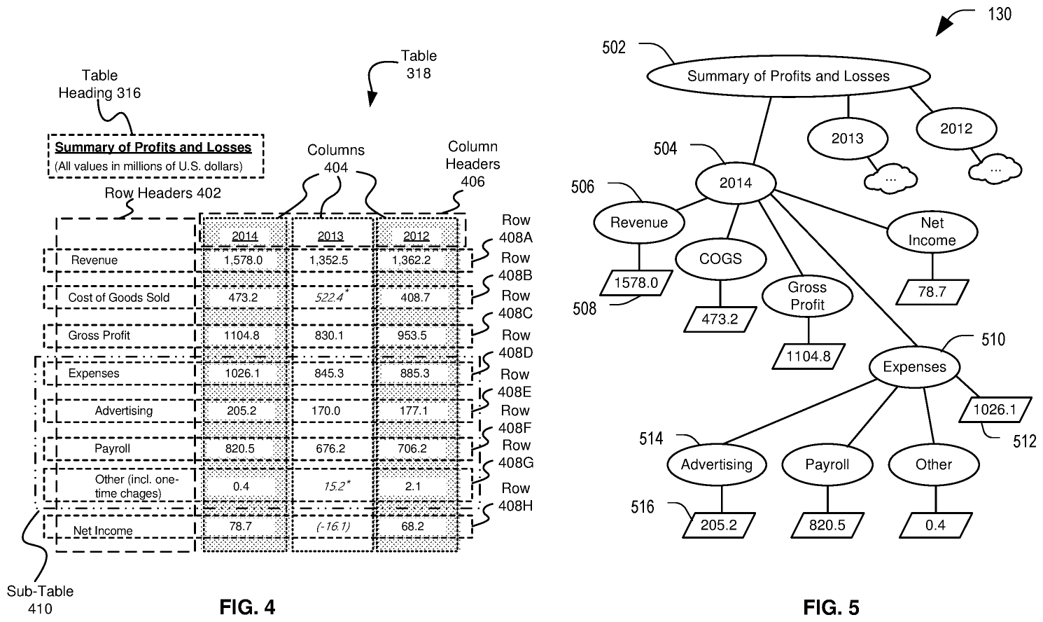

In some implementations, subregions of certain types of functional regions 134 may also be identified and associated with boundaries 136. For example, in FIG. 3, a table heading 316 is associated with a boundary indicated by a dotted line. Additional subregions of the table 318 are illustrated and described with reference to FIG. 4.

Although FIG. 3 illustrates examples of six different types of functional regions, the electronic document(s) 124 can include more or fewer than six different types of functional regions. Examples of other types of functional regions include images and lists.

FIGS. 4 and 5 together illustrate aspects of generation of the searchable data structure 130 based on the electronic document(s) 124 according to a particular implementation of the system 100 of FIG. 1. The example illustrated in FIG. 4 includes a diagram illustrating various functional subregions of the table 318, and FIG. 5 illustrates an example of a searchable data structure 130 based on the functional subregions of the table 318.

In FIG. 4, the functional subregions include the table heading 316, columns 404, column headers 406, rows 408A-408H, row headers 402, and a sub-table 410. In some implementations, one or more of the functional subregions of the table 318 includes its own subregions. To illustrate, in FIG. 4, the table 318 includes sub-table 410 as a functional subregion. In this illustrative example, the sub-table 410 may include one or more subregions, such as rows 408D-408G.

FIG. 5 represents the searchable data structure 130 as a connected graph or tree structure including multiple nodes. Each node is either a branch node having one or more subordinate nodes or a leaf node having no subordinate nodes. Each node stores text, category labels, other content items (e.g., embedded images), or a combination thereof, associated with a functional region or a functional subregion of the electronic document 124.

In the example illustrated in FIG. 5, the searchable data structure 130 includes a branch node 502 that represents the entire table 318 (also referred to as a root node), and the branch node 502 stores text associated with the entire table, such as text of the table heading 316. In this example, the searchable data structure 130 also includes a set of branch nodes corresponding to the columns 404 of the table 318, each of which stores text of a respective column header. To illustrate, branch node 504 corresponds to a column with the column header text “2014”. In the example illustrated in FIG. 5, the branch node 502 is also coupled to other subordinate nodes corresponding to other columns 404 of the table 318.

Further, in this example, the searchable data structure 130 includes several nodes that are subordinate to the branch node 504, such as node 506 and node 510. The node 506 is an example of a node that corresponds to a row of the table 318, and as such, the node 506 stores text of one of the row headers 402 (e.g., “Revenue” corresponding to row 408A). Further, in the example of FIG. 5, the node 506 is coupled to a leaf node 508 that include a content item (e.g., a value or text representing a value) associated with a table data element associated with the “2014” column and the “Revenue” row of the table 318. In the example illustrated in FIG. 5, the branch node 504 is also coupled to other subordinate nodes corresponding to other rows 408 of the table 318.

In the example of FIG. 5, the node 510 stores text (e.g., “Expenses”) representing row 408D, which is a summary row of the sub-table 410. The node 510 is coupled to a leaf node 512 that includes a content item (e.g., a value or text representing a value) associated with a table data element associated with the “2014” column and the “Expenses” row of the table 318. The node 510 is also coupled to subordinate nodes representing portions of the sub-table 410. For example, the node 510 is coupled to node 514, which represents row 408E of the sub-table 410 and stores corresponding text (e.g., “Advertising”). The node 510 and each of the other nodes at the same hierarchical level of the searchable data structure 130 are coupled to respective leaf nodes that include content items (e.g., a value or text representing a value) from the table 318. To illustrate, the node 510 is coupled (via the node 514) to a leaf node 516 that stores the value 205.2 (or text representing the value), which corresponds to the “Advertising” row 408E and the “2014” column of the sub-table 410 of FIG. 4.

FIG. 5 represents an example of the searchable data structure 130 formatted as a tree or graph. In other implementations, other hierarchical arrangements of data may be used. In a particular implementation, the topology of the searchable data structure 130 is determined based on the category labels assigned by the document parsing model(s) 114 of FIG. 1. For example, the searchable data structure 130 illustrated in FIG. 5 includes three branch nodes coupled to the branch node 502 because the table 318 includes three data columns 404. If the table 318 includes seven data columns 404, the searchable data structure 130 of FIG. 5 would include seven branch nodes coupled to the branch node 502. As another example, the table 318 includes a sub-table 410 listing examples of Expenses, and as a result, the node 510 of the searchable data structure 130 includes subordinate nodes corresponding to the rows of the sub-table 410.

In other implementations, the searchable data structure 130 hierarchically arranges information derived from the table 318 in a different manner. To illustrate, nodes representing the columns 404 of the table 318 may be subordinate to nodes representing the rows 408 of the table 318.

In the example illustrated in FIGS. 2-4, the table 318 does not include gridlines. In other examples, a table includes gridlines that define or distinguish table data cells, columns, rows, headers, or a combination thereof. In the example illustrated in FIGS. 2-4, the data cells, columns, rows, headers, or a combination thereof, of the table 318 are distinguished by alignment, spacing, position, font characteristics, background color, or a combination thereof. To illustrate, the document parsing model(s) 114 of FIG. 1 may identify the columns 404 of the table 318 based on vertical (with respect to a page orientation) alignment of text of each of the columns 404. As another illustrative example, the document parsing model(s) 114 of FIG. 1 may identify the columns 404 of the table 318 based on the presence of vertical background color bands (illustrated with shading in FIG. 5). In some implementations, the document parsing model(s) 114 may also consider other factors, such as the presence of column headers 406. It should be understood that the examples above are merely illustrative. When the document parsing model(s) 114 are a trained machine-learning model, it may not be obvious to a human observer which specific information represented by the input data 126 results in a specific functional region 134 of an electronic document 124 being identified as a table, a column, a row, etc.

In some implementations, one or more of the columns 404 may not be associated with a column header 406. In such implementations, the NLP model(s) 116 can be used to determine a semantic group represented by text of data elements of the column. For example, if the table 318 included a set of vertically aligned data elements with no clear column heading and including the text such as: Dallas, Miami, Tokyo, London, and Mumbai, the NLP model 116 may determine a column header for the column based on a semantic analysis of the text of the data elements. In this example, the column header may be, for example, “City”.

An interconnected set of nodes of the searchable data structure 130 of FIG. 5 define a data path that can be used to generate a rule of the search heuristic(s) 122 of FIG. 1. To illustrate, if a user searches for advertising expenses in 2014 and indicates that the data path:
Summary of Profits and Losses|2014|ExpenseslAdvertising

provides the sought after information, a rule can be generated indicating that advertising for a particular year (“Year”) may be accessed at data path:
Summary of Profits and Losses|Year|ExpenseslAdvertising

Accordingly, if a user subsequently generates a query for Advertising expenses for another year, the search query may be supplemented with information from the data path to improve knowledge retrieval.

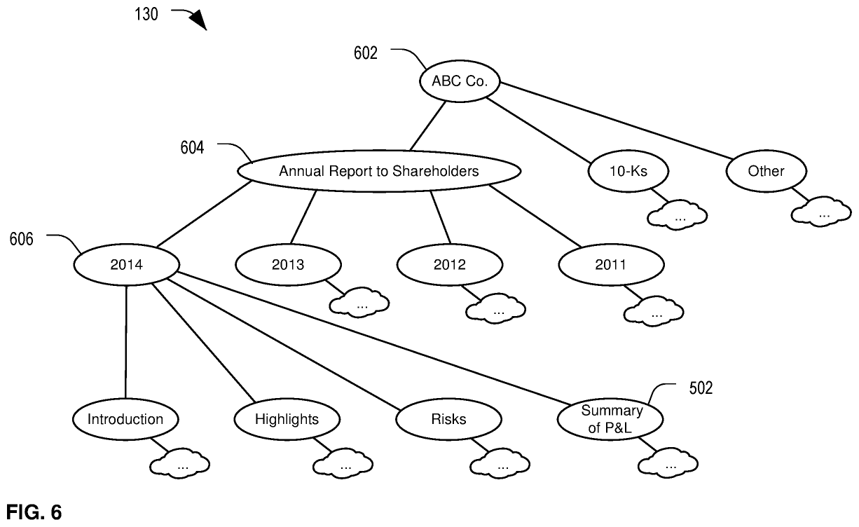

FIG. 6 is a diagram illustrating at least a portion of a searchable data structure 130 according to a particular implementation of the system 100 of FIG. 1. In the example illustrated in FIG. 6, the searchable data structure 130 stores data based on an entire corpus of electronic documents, such as records of a company. FIG. 6 represents the searchable data structure 130 formatted as a tree or graph; however, in other implementations, other hierarchical arrangements of the data are used.

As described with reference to FIG. 5, the topology of the searchable data structure 130 may be determined based on the category labels assigned by the document parsing model(s) 114 during processing of the corpus of electronic documents. For example, the searchable data structure 130 illustrated in FIG. 6 includes a root node 602 and three branch nodes subordinate to the root node 602. The root node 602, in this example, stores data derived from page headers, page footers, coversheets, or other functional regions that are common to many of the electronic documents of the corpus and that are associated with particular category labels. In the particular example illustrated in FIG. 6, the branch nodes stemming from the root node 602 represent particular categories or types of electronic documents, such as annual shareholder reports 604, 10-K filings, and other documents. In other examples, the searchable data structure 130 includes more, fewer, or different brand nodes coupled to the root node 602.

In the example illustrated in FIG. 6, the node 502 and nodes subordinate thereto store data derived from the table 318 of FIGS. 3 and 4. For example, the node 502 of FIG. 6 may be coupled to one or more of the nodes illustrated in FIG. 5. As explained with reference to FIG. 5, the searchable data structure 130 of FIG. 6 defined data paths that can be used to generate the search heuristic(s) 122.

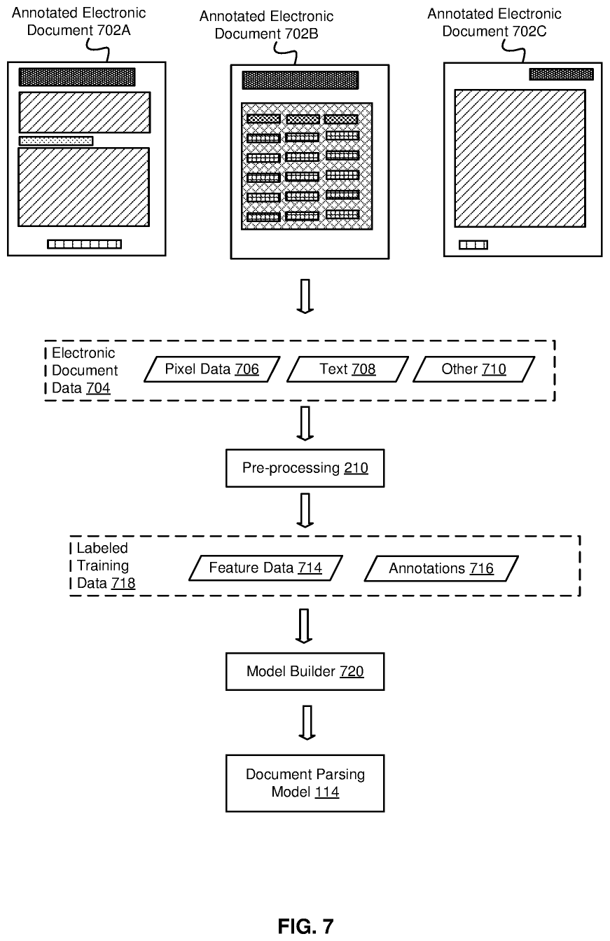

FIG. 7 is a diagram illustrating aspects of generating the document parsing model(s) 114 of FIG. 1. The operations described with reference to FIG. 7 may be performed by the processor(s) 104 of FIG. 1 executing instructions 110 from the memory device(s) 106. For example, the instructions 110 may include a model builder 720, as described further below, which may be executed by the processor(s) 104. Alternatively, in some implementations, the operations described with reference to FIG. 7 may be performed by another computing device, and the document parsing model(s) 114 can subsequently be provided to the computing device(s) 102 for execution.

The operations illustrated in FIG. 7 use a set of annotated electronic documents (e.g., documents 702A, 702B, 702C). Various functional regions are annotated in each of the annotated electronic documents 702. The annotations indicate boundaries of the various functional regions and a category label associated with each. The category labels indicate the function (e.g., the syntactical or structural purpose) of content within each functional region. Examples of category labels include page headers, page footers, section headings, paragraphs, tables, images, footnotes, and lists.

The annotated electronic documents 702 are stored as, include, or correspond to electronic document data 704. The electronic document data 704 includes pixel data 706, text 708, other data 710, or a combination thereof. The electronic document data 704 is provided as input to the pre-processing instructions 210 to generate feature data 714. In a particular implementation, the feature data 714 includes a vector of values representing the electronic document data 704.

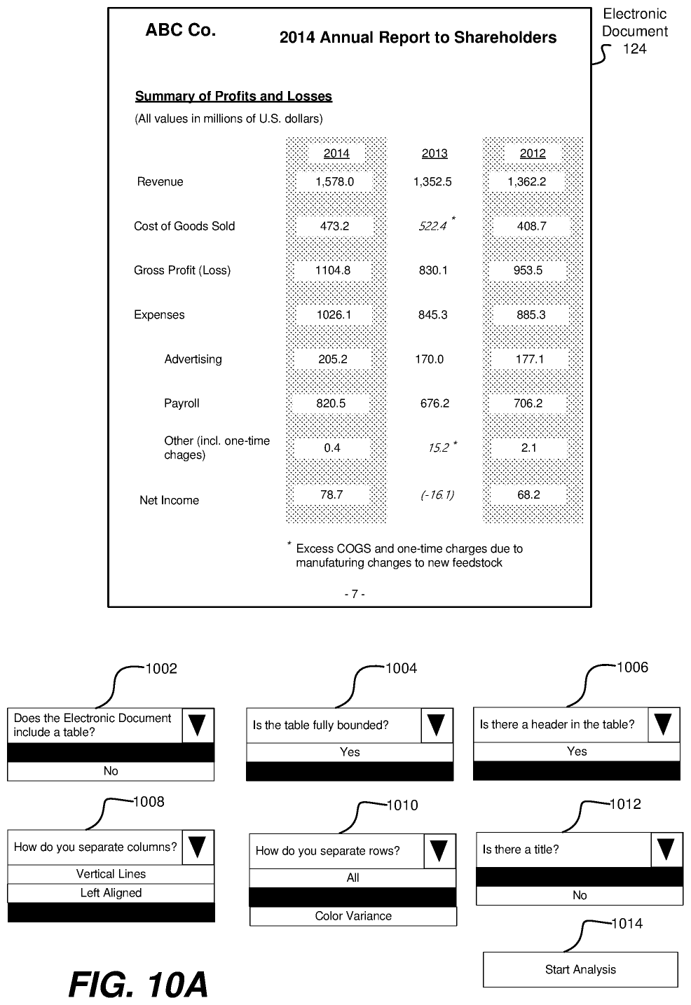

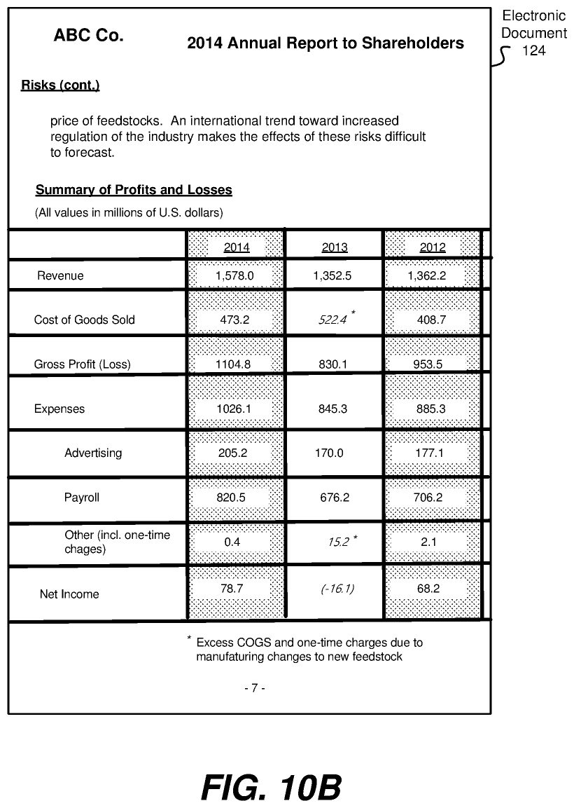

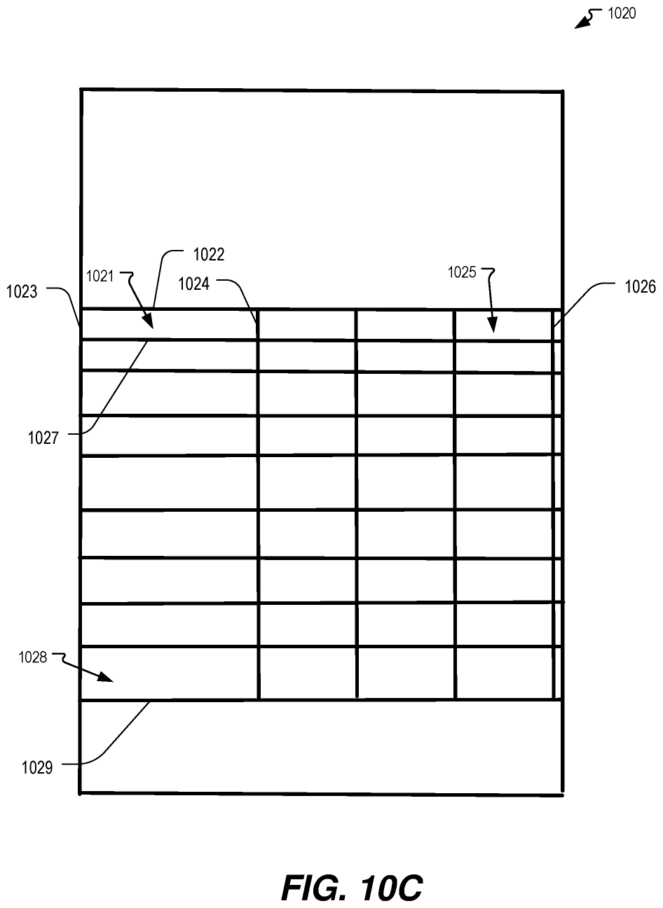

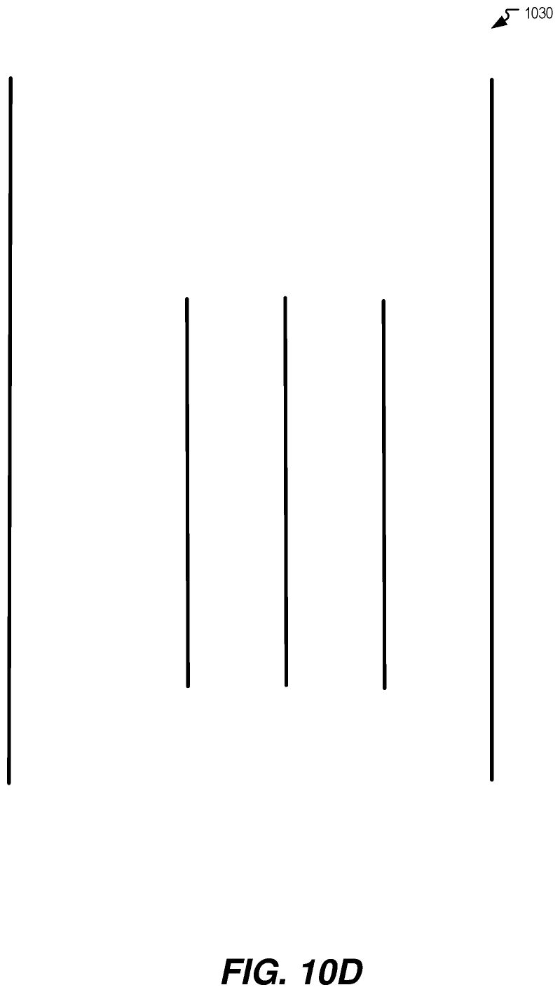

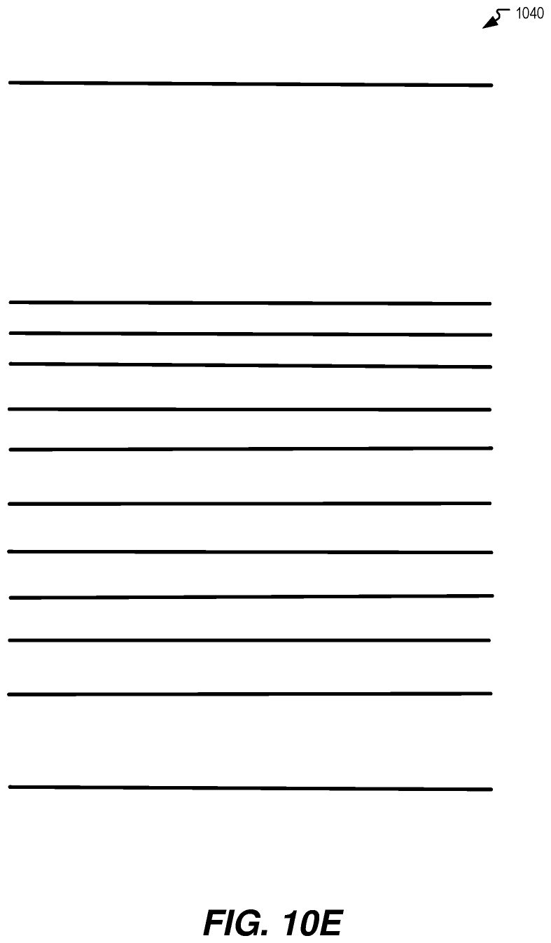

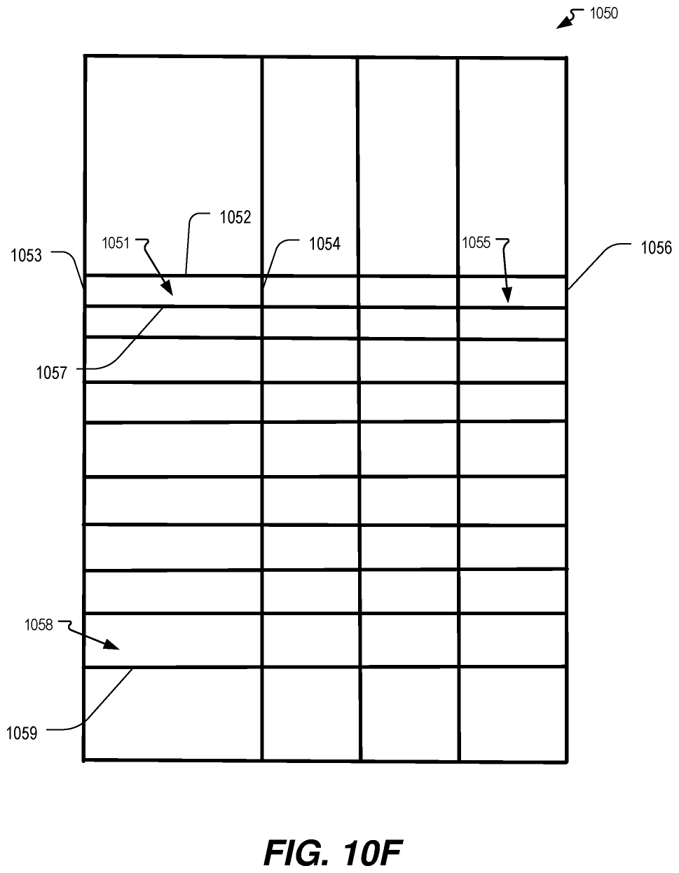

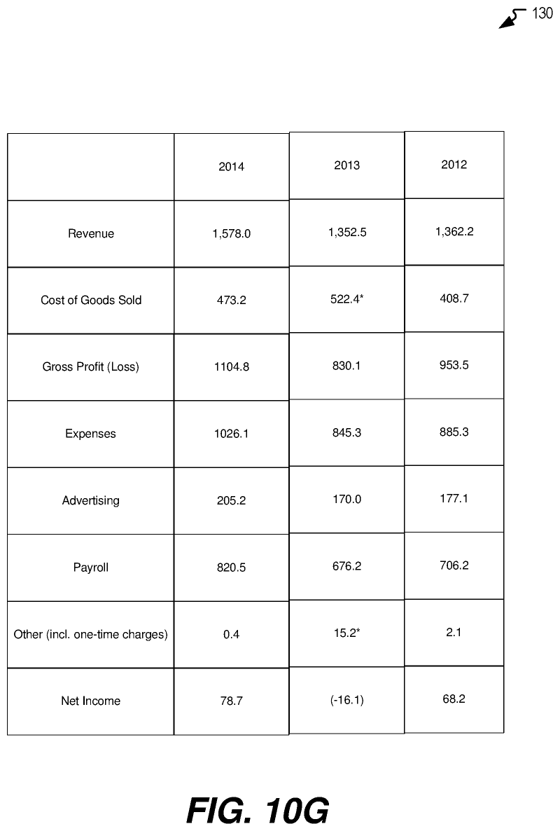

The feature data 714 and data representing the annotations 716 are provided as labeled training data 718 to model builder 720. The model builder 720 is configured to perform operations to generate the document parsing model(s) 114, the NLP model(s) 116, or both. An example of the model builder 720 is described with reference to FIG. 10.

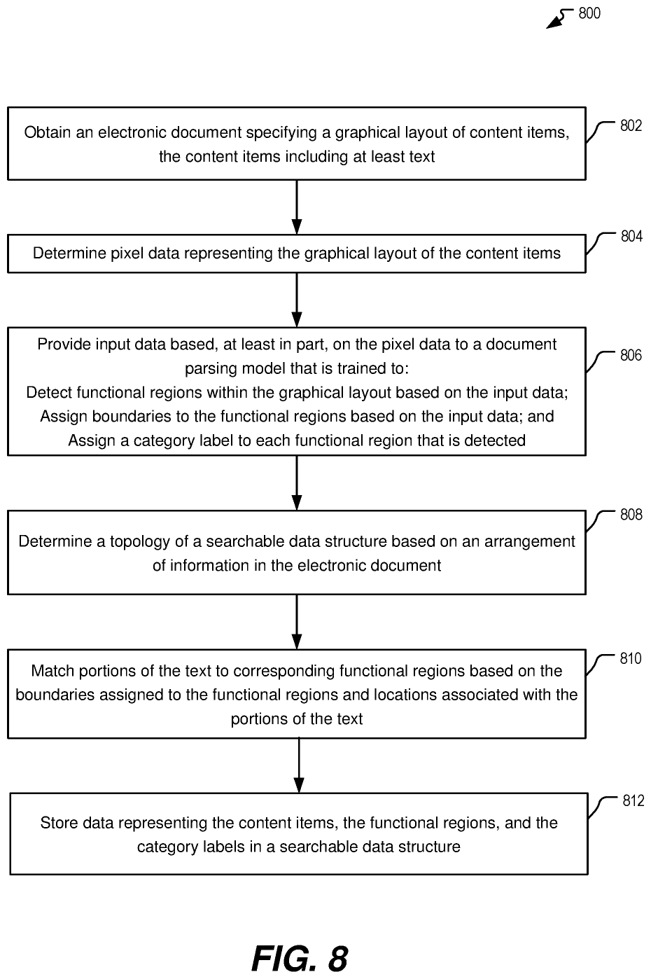

FIG. 8 is a flow chart of an example of a method 800 that can be initiated, controlled, or performed by the system 100 of FIG. 1. The method 800 includes an example of operations that may be performed to generate the searchable data structure 130 based on an electronic document 124.

The method 800 includes, at 802, obtaining an electronic document specifying a graphical layout of content items, where the content items include at least text. For example, the electronic document data 202 representing the electronic document 124 may be accessed from the memory device(s) 106, the data repository 150, or both. The electronic document may include, for example, an image file representing a scanned document, a text editor document, a mark-up language document, a portable document format document, a spreadsheet, a document in another business office format, or a combination thereof (e.g., linked or cross-referenced files that form a single document for display).

The method 800 includes, at 804, determining pixel data representing the graphical layout of the content items. The pixel data defines a plurality of display elements to render a display of the electronic document, and each display element encodes at least one color bit representing a display color of the display element.

The method 800 includes, at 806, providing input data based, at least in part, on the pixel data to one or more of the document parsing model(s) 114. The document parsing model(s) 114 are trained to detect functional regions 134 within the graphical layout based on the input data. For example, the functional regions 134 detected by a document parsing model(s) 114 may include two or more of a page header, a page footer, a section heading, a paragraph, a table, an image, a footnote, or a list.

Additionally, the document parsing model(s) 114 are trained to assign boundaries 136 to the functional regions 134 based on the input data and to assign a category label 140 to each functional region 134 that is detected. For example, a document parsing model assigns a category label to a particular functional region based on a probabilistic analysis of the pixel data associated with the particular functional region. In a particular implementation, the input data is further based on text of the electronic document, and a document parsing model assigns category label(s) further based, at least in part, on a semantic analysis of the text.

In some implementations, the data specifying the graphical layout of the content items indicates font characteristics for particular text associated with a particular functional region, and a document parsing model assigns a particular category label to the particular functional region based on at least one of the font characteristics of the particular text or a change of the font characteristics between the particular functional region and an adjacent functional region. In some implementations, the data specifying the graphical layout of the content items indicates character spacing in particular text associated with a particular functional region, and a document parsing model assigns a particular category label to the particular functional region based on at least one of the character spacing of the particular text or a change of the character spacing between the particular functional region and an adjacent functional region. In some implementations, the data specifying the graphical layout of the content items indicates a background color associated with a particular functional region, and a document parsing model assigns a particular category label to the particular functional region based on at least one of the background color or a change in background color between the particular functional region and an adjacent functional region. In some implementations, text of a particular functional region includes one or more special characters, and a document parsing model assigns a particular category label to the particular functional region based on a determination that the one or more special characters are present in the particular function region.

In some implementations, an electronic document includes a functional region that is identified (e.g., labeled by the document parsing model(s) 114) as a table. In such implementations, one or more of the document parsing model(s) 114 may identify various portions (e.g., subregions) of the table, such as columns, rows, cells, etc. For example, a document parsing model may estimate column boundaries and row boundaries based on the input data associated with the particular functional region. A document parsing model may also determine a column heading of a column based on the text associated within the particular functional region. For example, a document parsing model may cause a natural-language processing model to determine a semantic group represented by text of the column, and the document parting model may assign the column heading based on the semantic group identified by the natural-language processing model. A document parsing model may store a portion of the text associated within the particular functional region in a first data element of the searchable data structure and store the column heading of the column in a second data element, where the first data element is subordinate to the second data element in the searchable data structure.

In some implementations, the method 800 includes, at 808, determining a topology of the searchable data structure 130 based on an arrangement of information in the electronic document 124. For example, the category labels 140 assigned by the document parsing model(s) 114 may be mapped to hierarchy data that indicates an order to be associated with various types of functional regions 134. To illustrate, the hierarchy data may indicate that a functional region labeled as a paragraph is subordinate to a functional region labeled as a section heading. In some implementations, the searchable data structure 130 has a tree structure including a plurality of leaf nodes. In such implementations, each leaf node is associated with a corresponding branch node, and the content items are assigned to nodes of the tree structure such that a hierarchy of the functional regions is represented in the tree structure.

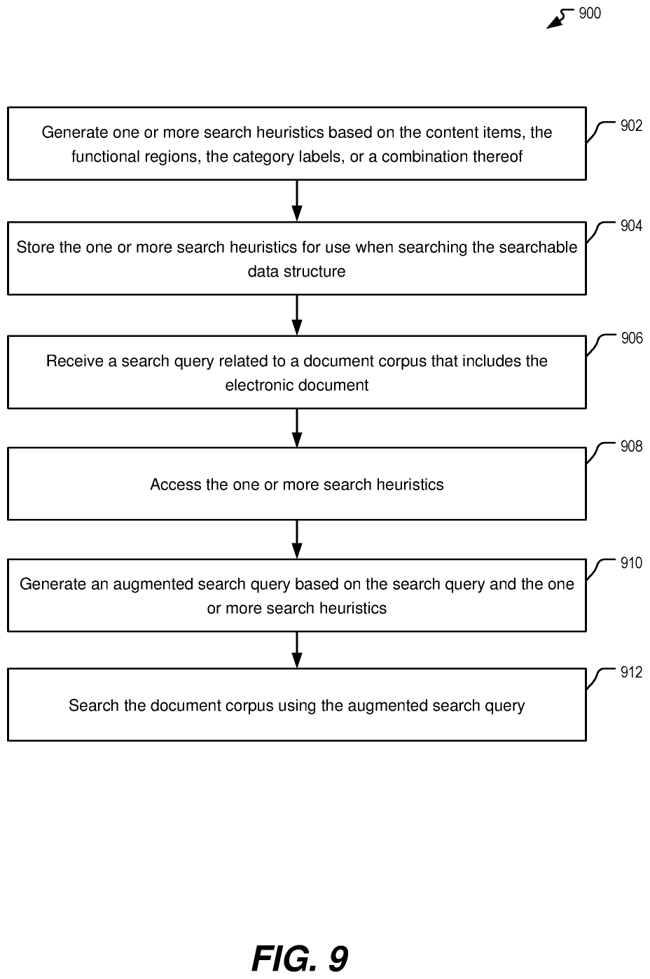

The method 800 also includes, at 810, matching portions of the text to corresponding functional regions based on the boundaries assigned to the functional regions and locations associated with the portions of the text and, at 812, storing data representing the content items, the functional regions, and the category labels in the searchable data structure. A searchable data structure 130 formed according to the method 800 is a knowledge representation of the electronic document(s) 124 used to form the searchable data structure 130. Additionally, the searchable data structure 130 has a smaller in-memory footprint than electronic document(s) 124 and can be used to form search heuristic(s) 122 that improve information retrieval, as described further with reference to FIG. 9.

FIG. 9 is a flow chart of another example of a method 900 that can be initiated, controlled, or performed by the system of FIG. 1. The method 900 includes an example of operations that may be performed to facilitate information retrieval from a searchable data structure 130 based on a document corpus (e.g., a collection of electronic documents).

The method 900 includes, after storing data in the searchable data structure, such as the searchable data structure 130 of FIG. 1, generating one or more search heuristics based on the content items, the functional regions, the category labels, or a combination thereof, at 902. For example, a rule of the one or more search heuristics may indicate a data path to retrieve particular information.

The method 900 also includes, at 904, storing the search heuristic(s) for use when searching the searchable data structure. For example, the search heuristic(s) 122 may a search query or search terms or search results and a data path that was used to retrieve information sought by the search query.

After storing the search heuristic(s), the method 900 includes, at 906, receiving a search query related to the document corpus and, at 908, accessing the search heuristic(s). The method 900 further includes, at 910, generating an augmented search query based on the search query and the search heuristic(s) and, at 912, searching the document corpus using the augmented search query. For example, the search query may be augmented by addition of a relevant data path to the search query or to a portion of the search query.

Referring to FIGS. 10A-10G, a particular illustrative example of generating a searchable representation of an electronic document is shown.

FIG. 10A illustrates prompts 1002-1012 that are presented to a user that enables the computing device 102 to select masking rules. For example, the processor 104 can generate a graphical user interface that displays the electronic document 124 and presents the prompts 1002-1012 to the user for user input. As described herein, the prompts 1002-1012 may include questions and user selectable options that enable the user to describe a table in the electronic document 124. Based on the answers to the questions, the processor 104 may select masking rules.

To illustrate, a first prompt 1002 may inquire from the user whether the electronic document 124 or a portion thereof (e.g., a displayed page of the electronic document 124) includes a table. The user can analyze the electronic document 124 and answer the first prompt 1002 using a dropdown selector or other user selectable option. In some implementations, a definition for a “table” can be provided to the user to assist in answering the first prompt 1002. According to the example of FIG. 10A, the user may determine that the electronic document 124 includes a table, and the user can select the “yes” option. Upon answering the first prompt 1002, the user may be presented with a second prompt 1004.

The second prompt 1004 may inquire from the user whether the table is fully bounded. The user can analyze the electronic document 124, more specifically the table, and answer the second prompt 1004 using a dropdown selector or other user selectable option. In some implementations, a definition or example of a “fully bounded” table can be provided to user to assist in answering the second prompt 1004. According to the example of FIG. 10A, the user may determine that the table is not fully bounded, and the user can select the “no” option. Upon answering the second prompt 1004, the user may be presented with a third prompt 1006.

The third prompt 1006 may inquire from the user whether the table includes a header. The user can analyze the electronic document 124, more specifically the table, and answer the third prompt 1006 using a dropdown selector or other user selectable option. In some implementations, a definition or example of a “header” can be provided to the user to assist in answering the third prompt 1006. According to the example of FIG. 10A, the user may determine that the table does not include a header and the user can select the “no” option. Upon answering the third prompt 1006, the user may be presented with a fourth prompt 1008.

The fourth prompt 1008 may inquire from the user how the columns in the table are separated. The user can analyze the electronic document 124, more specifically the table, and answer the fourth prompt 1008 using a dropdown selector or other user selectable option. In some implementations, examples of different ways to separate columns can be provided to the user to assist in answering the fourth prompt 1008. According to the example of FIG. 10A, the user may determine that the columns are separated using a “mixed align” technique and may select the corresponding option. Upon answering the fourth prompt 1008, the user may be presented with a fifth prompt 1010.

The fifth prompt 1010 may inquire from the user how the rows in the table are separated. The user can analyze the electronic document 124, more specifically the table, and answer the fifth prompt 1010 using a dropdown selector or other user selectable option. In some implementations, examples of different ways to separate rows can be provided to the user to assist in answering the fifth prompt 1010. According to the example of FIG. 10A, the user may determine that the rows are not uniformly separated by common technique and may select the corresponding option. Upon answering the fifth prompt 1010, the user may be presented with a sixth prompt 1012.

The sixth prompt 1012 may inquire from the user whether the table includes a title. The user can analyze the electronic document 124, more specifically the table, and answer the sixth prompt 1012 using a dropdown selector or other user selectable option. In some implementations, a definition or example of a “title” can be provided to the user to assist in answering the sixth prompt 1012. According to the example of FIG. 10A, the user may determine that the table does include a title and the user can select the “yes” option. Upon answering the sixth prompt 1012, the user may be select a prompt 1014 that enables the processor 104 to start an analysis and draw initial vertical and horizontal masks, as illustrated in FIG. 10B.

The prompts 1002-1012 and the selection of answers in the corresponding dropdown menus are merely illustrative and are not intended to be limiting. In other implementations, additional prompts can be presented to the user and additional answers can be presented to the user. Furthermore, in other implementations, prompts can be presented to the user in different formats. As a non-limiting examples, prompts can be presented to the user using a box-check format, a bubble-fill format, etc. Additionally, according to some implementations, the prompts 1002-1012 can be presented to the user or displayed according to a different sequence. As a non-limiting example, the prompt 1004 can be displayed or presented prior to the prompt 1002. According to another implementation, all or multiple prompts can be displayed or presented concurrently.

FIG. 10B illustrates an overlay of the electronic document 124. The overlay includes vertical that indicate column boundaries and horizontal lines that indicate row boundaries of a table in the electronic document 124.

According to one implementation, the processor 104 may generate the overlay based on the answers to the prompts 1002-1012 of FIG. 10A. For example, in response to answering the prompts 1002-1012, the processor 104 can analyze the electronic document 124 to determine where column and row lines are likely to define the table. Based on the analysis, the processor 104 can generate the overlay that is shown on top of the electronic document 124.

According to another implementation, the processor 104 may generate the overlay based on a document type. For example, if the electronic document 124 has a particular format or type that is readily identifiable to the processor 104 upon analysis, the processor 104 can identify the table columns and table rows based on the particular format or type.

FIG. 10C illustrates a first computer-generated table 1020 that is generated based on the answer to the prompts 1002-1012 in FIG. 10A, the overlay in FIG. 10B, other table generation techniques, or a combination thereof. According to one implementation, the first computer-generated table 1020 may be generated from the electronic document 124 as part of an image preparation process.

The first computer-generated table 1020 can be generated by extracting line objects of partially or fully bounded tables. For example, the lines in the table of the electronic document 124 may be extracted to generate at least a portion of the first computer-generated table 1020. However, as indicated by the answer to the prompt 1004, the table in the electronic document 124 is not fully bounded. Thus, additional or alternative techniques may be required to generate the first computer-generated table 1020. For example, a table layout schema-based analysis can be performed based on the answers to the prompts 1002-1012 to generate the first computer-generated table 1020. Additionally, text masking may be performed to reduce noise and identify vertical lines in the first computer-generated table 1020.

FIG. 10D illustrates a vertical mask 1030 that is generated from the first computer-generated table 1020. The vertical mask 1030 may indicate estimated locations of vertical boundaries of table columns of the table in the electronic document 124.

To generate the vertical mask 1030, the processor 104 may apply a morphological transformation to a base image (e.g., the first computer-generated table 1020) to extract vertical lines for the vertical mask 1030. The parameterization of the morphological transformation may include a vertical and horizontal pixel size. The processor 104 may use a text font size in the electronic document 124 to exclude text characters and capture cell separators. The processor 104 may generate the vertical mask 1030 by assigning a first pixel value, such as pixel value of zero (0), to each pixel that corresponds to an estimated location of one of the vertical boundaries. In some implementations, the processor 104 can create vertical line widths that span multiple pixels based on masking rules or user input to the prompts 1002-1012.

According to other implementations, the vertical mask 1030 may be generated based on masking rules. The masking rules may be selected based on a document type of the electronic document 124, based on user response to the prompts 1002-1012, or based on the document type and the user responses.

According to one implementation, the processor 104 may normalize vertical lines in the vertical mask 1030 that are within threshold distances of other vertical lines. As a non-limiting example, if one vertical line is within 10 pixels of another vertical line, the processor 104 may combine these two vertical lines to generate a normalized vertical line of the vertical mask 1030. The normalized line may be located between the two vertical lines. A blur function may be used to smooth the normalized vertical line. The normalization process may be used to consolidate lines segments that have been identified as a few pixels apart. The smoothing process may reduce errors from imperfectly aligned column line segments.

The processor 104 may traverse the columns of the vertical mask 1030 to find columns that are non-white. To illustrate, if a mean pixel value of a particular column is less than a particular pixel value, the processor 104 may determine that the particular column is a non-white column. As a non-limiting example, if the processor 104 determines that the mean pixel value of the particular column is less than 254, where a pixel value of 0 represents a black pixel and a pixel value of 255 represents a white pixel, the processor 104 may determine that the particular column is a non-white column.

FIG. 10E illustrates a horizontal mask 1040 that is generated from the first computer-generated table 1020. The horizontal mask 1040 may indicate estimated locations of horizontal boundaries of table rows of the table in the electronic document 124.

To generate the horizontal mask 1040, the processor 104 may apply a morphological transformation to a base image (e.g., the first computer-generated table 1020) to extract horizontal lines for the horizontal mask 1040. The parameterization of the morphological transformation may include a vertical and horizontal pixel size. The processor 104 may use a text font size in the electronic document 124 to exclude text characters and capture cell separators. The processor 104 may generate the horizontal mask 1040 by assigning a first pixel value, such as pixel value of zero (0), to each pixel that corresponds to an estimated location of one of the horizontal boundaries. In some implementations, the processor 104 can create horizontal line widths that span multiple pixels based on masking rules or user input to the prompts 1002-1012.

According to other implementations, the horizontal mask 1040 may be generated based on masking rules. The masking rules may be selected based on a document type of the electronic document 124, based on user response to the prompts 1002-1012, or based on the document type and the user responses.

According to one implementation, the processor 104 may normalize horizontal lines in the horizontal mask 1040 that are within threshold distances of other horizontal lines. As a non-limiting example, if one horizontal line is within 20 pixels of another horizontal line, the processor 104 may combine these two horizontal lines to generate a normalized horizontal line of the horizontal mask 1040. A blur function may be used to smooth the normalized horizontal line. The normalization process may be used to consolidate lines segments that have been identified as a few pixels apart. The smoothing process may reduce errors from imperfectly aligned row line segments.

The processor 104 may traverse the rows of the horizontal mask 1040 to find rows that are non-white. To illustrate, if a mean pixel value of a particular row is less than a particular pixel value, the processor 104 may determine that the particular row is a non-white row. As a non-limiting example, if the processor 104 determines that the mean pixel value of the particular row is less than 254, where a pixel value of 0 represents a black pixel and a pixel value of 255 represents a white pixel, the processor 104 may determine that the particular row is a non-white row.

FIG. 10F illustrates a second computer-generated table 1050 that is generated based on the vertical mask 1030 and the horizontal mask 1040. In particular, the second computer-generated table 1050 depicts possible candidate cells generated by overlaying the vertical lines in the vertical mask 1030 and the horizontal lines in the horizontal mask 1040. The second computer-generated table 1050 forms a fixed set of rows and columns with left, right, top, and bottom pixel bounds.

Using a layout generation algorithm based on the first computer-generated table 1020 and the second computer-generated table 1050, the processor 104 is configured to iterate through the cells in the first computer-generated table 1020 to identify anchors. For example, the processor 104 may overlay the first computer-generated table 1020 with the second computer-generated table 1050 (e.g., the masks). An anchor can be identified as an overlapping top and left edge (e.g., bound). From the anchor, the processor 104 can iterate through cells to the right to find the column span of the anchored cell and can iterate through cells to underneath to find the row span. The layout generation algorithm can be used to generate the table illustrated in FIG. 10G.

For example, using the layout generation algorithm, the processor 104 may identify cells in the table of FIG. 10G by performing cell edge comparisons between the first computer-generated table 1020 and the second computer-generated table 1050 (e.g., the vertical and horizontal masks 1030, 1040). The left and right cell edges of the first computer-generated table 1020 are compared to the vertical mask 1030, and the top and bottom cell edges of the first computer-generated table 1020 are compared to the horizontal mask 1040. Thus, identifying the cells in the table of FIG. 10G may include designating a vertical cell boundary based on a number of pixels in a vertical search region that have the first pixel values (e.g., pixel values of 0) and designating a horizontal cell boundary based on a number of pixels in a horizontal search region that have the first pixel values.

According to the layout generation algorithm, the processor 104 is configured to iterate through each cell in a first row of the first computer-generated table 1020. Starting with a first cell 1021 in the first row of the first computer-generated table 1020, the processor 104 is configured to compare a top edge 1022 of the first cell 1021 to the horizontal mask 1040 and compare a left edge 1023 of the first cell 1021 to the vertical mask 1030. If the top and left edges 1022, 1023 are valid edges, the processor 104 is configured to anchor the first cell 1021 by setting a top edge 1052 of a corresponding cell 1051 of the second computer-generated table 1050 to the top edge 1022 of the first cell 1021 and by setting a left edge 1053 of the corresponding cell 1051 to the left edge 1023 of the first cell 1021. As used herein, a “valid edge” corresponds to a solid line of a table that is comprised of black pixels and defines a boundary of a cell of the table. The processor 104 may determine that the top and left edges 1022, 1023 are valid based on pixel values. For example, a pixel value of zero (0) may correspond to a valid edge and a pixel value of two-hundred fifty-five (255) may correspond to a non-valid edge.

Additionally, if the top and left edges 1022, 1023 are valid edges, the processor 104 is configured to find the column span by checking for a right edge 1024 of the first cell 1021. In response to finding the right edge 1024 of the first cell 1021, the processor 104 can determine the distance between the left edge 1023 and the right edge 1024 and set the distance to a value of one (1) as the “column span.” Thus, if another column has a larger distance, the column span of that column would be larger than one (1). The processor 104 can iterate the first cell 1021 through the first row to a rightmost cell 1025 and compare a right edge 1026 of the rightmost cell 1025 to the vertical mask 1030. If the right edge 1026 is valid, the processor 104 is configured to set a right edge of a corresponding cell 1055 of the second computer-generated table 1050 to the right edge 1026 of the rightmost cell 1025. Otherwise, the processor 104 may increment the column span. In the illustrated example, the right edge 1026 of the rightmost cell 1025 is not a valid edge. Thus, the column span is incremented to such that the right edge 1056 of the rightmost cell 1055 in the second computer-generated table 1050 is used in the table of FIG. 10G.

Next, the processor 104 may find the row span by checking for a bottom edge 1027 of the first cell 1021. In response to finding the bottom edge 1027 of the first cell 1021, the processor 104 can determine the distance between the top edge 1022 and the bottom edge 1027 and set the distance to a value of one (1) as the “row span.” Thus, if another row has a larger distance, the row span of that row would be larger than one (1). The processor 104 can iterate the first cell 1021 through the first column to a bottommost cell 1028 and compare a bottom edge 1029 of the bottommost cell 1028 to the horizontal mask 1040. If the bottom edge 1029 is valid, the processor 104 is configured to set a bottom edge 1059 of a corresponding cell 1058 of the second computer-generated table 1050 to the bottom edge 1029 of the bottommost cell 1028. Otherwise, the processor 104 may increment the row span.

The processor 104 may iterate the above process through each row to generate the table of FIG. 10G. Thus, the layout generation algorithm described above compares edges in the first computer-generated table 1020 to edges of all the potential cells in the second computer-generated table 1050 to infer row spans and column spans for merged cells. For example, the layout generation algorithm asserts that a cell is anchored to left and top sides, the column spans are found by looking for a right side of the cell, and the row spans are found by looking for the bottom side of the cell.

FIG. 10G depicts a searchable data structure 130 (e.g., a machine-readable table) that is generated based on the layout generation algorithm. According to one implementation, the searchable data structure 130 can be populated using natural language processing (NLP) techniques. It should be appreciated that the searchable data structure 130 can be exported to different formats, such as a comma-separated values (CSV) file, a HyperText Markup Language (HTML) file, an XLS file, etc. Thus, generation of the searchable data structure 130 can be automated based on answers to the prompts 1002-1012 and the layout generation algorithm described with respect to FIGS. 10A-10G. It should be appreciated that, upon generation of the searchable data structure 130, the processor 104 can automatically generate searchable data structures without the user having to answer the prompts, as depicted in FIG. 10A.

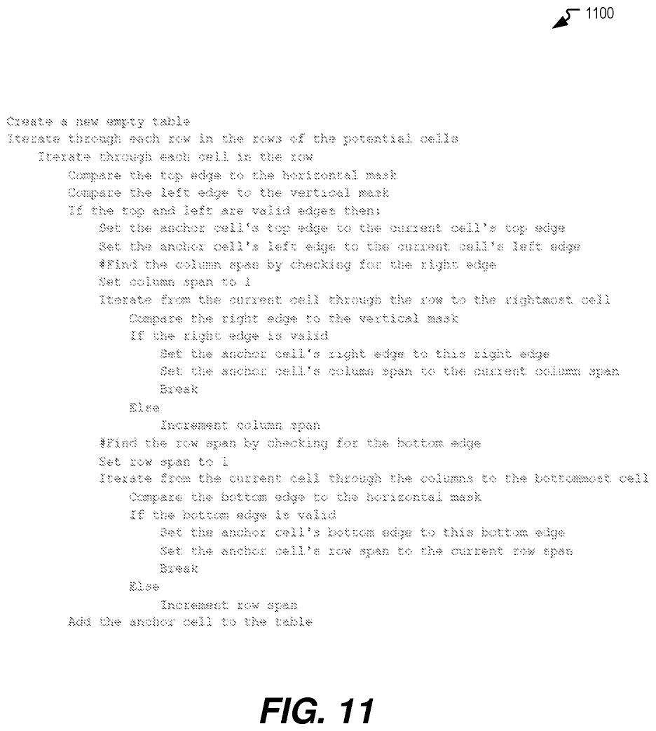

FIG. 11 is an example of pseudocode 1100 for the layout generation algorithm described with respect to FIGS. 10A-10G. According to the pseudocode 1100, the processor 104 is configured to create a new first computer-generated table. For example, the processor 104 may create the first computer-generated table 1020 of FIG. 10C.

Based on the pseudocode 1100, the processor 104 is configured to iterate through each cell in the first row of the first computer-generated table 1020 with the below-described process. First, the processor 104 may compare the top edge 1022 of the first cell 1021 in first row to the horizontal mask 1040 and compare the left edge 1023 of the first cell 1021 to the vertical mask 1030. If the top and left edges 1022, 1023 are valid edges, the processor 104 may anchor the first cell 1021 by setting the top edge 1022 of the first cell 1021 to the top edge 1052 of the cell 1051 in the second computer-generated table 1050 and by setting the left edge 1023 of the first cell 1021 to the left edge 1053 of the cell 1051 in the second computer-generated table 1050.

Next, based on the pseudocode 1100, the processor 104 is configured to find the column span by detecting the right edge 1024 of the first cell 1021 in the corresponding cell 1051 of the second computer-generated table 1050. Upon detecting the right edge 1054, the processor 104 may set the column span to one (1). The processor 104 may iterate from the first cell 1021 through the first row to the rightmost cell 1025. The processor 104 may compare the right edge 1026 to the vertical mask 1030. If the right edge 1026 is valid, the processor may set the anchor cell's right edge to the rightmost cell's right edge and set the anchor cell's column span to the current column span. Otherwise, the processor 104 may increment the column span.

Next, based on the pseudocode 1100, the processor 104 is configured to find the row span by checking for the bottom edge 1027. Upon detecting the bottom edge 1027, the processor 104 may set the row span to one (1). The processor may iterate from the current cell (e.g., the first cell 1021) through the columns to the bottommost cell 1028 and compare the bottom edge 1029 to the horizontal mask 1040. If the bottom edge 1029 is valid, the processor 104 may set the anchor cell's bottom edge to the bottom edge and set the anchor cell's row span to the current row span. Otherwise, the processor 104 may increment the row span. The processor 104 may iterate the above process through each row to generate the table of FIG. 10G.

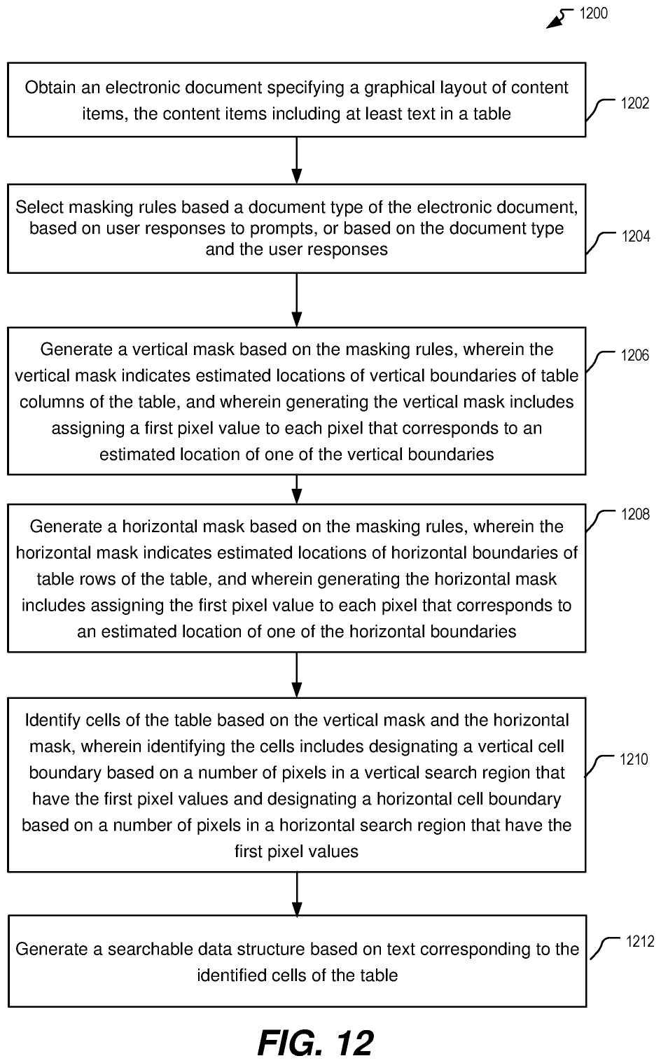

FIG. 12 is a flow chart of another example of a method 1200 that can be initiated, controlled, or performed by the system 100 of FIG. 1. The method 1200 includes an example of operations that may be performed to generate the searchable data structure 130 based on an electronic document 124.

The method 1200 includes obtaining an electronic document specifying a graphical layout of content items, at 1202. The content items may include at least text in a table. For example, referring to FIG. 10A, the processor 104 may obtain the electronic document 124.

The method 1200 also includes selecting masking rules based on a document type of the electronic document, based on user responses to prompts, or based on the document type and the user responses, at 1204. For example, the processor 104 may select masking rules for the vertical and horizontal masks 1030, 1040 based on user responses to the prompts 1002-1012 or based on a readily identifiable document type of the electronic document 124.

The method 1200 also includes generating a vertical mask based on the masking rules, at 1206. The vertical mask may indicate estimated locations of vertical boundaries of table columns of the table. Generating the vertical mask may include assigning a first pixel value to each pixel that corresponds to an estimated location of one of the vertical boundaries. For example, referring to FIG. 10D, the processor 104 may generate the vertical mask 1030. The vertical mask 1030 may be indicative of table columns in the electronic document 124.

The method 1200 also includes generating a horizontal mask based on the masking rules, at 1208. The horizontal mask may indicate estimated locations of horizontal boundaries of table rows of the table. Generating the horizontal mask may include assigning the first pixel value to each pixel that corresponds to an estimated location of one of the horizontal boundaries. For example, referring to FIG. 10E, the processor 104 may generate the horizontal mask 1040. The horizontal mask 1040 may be indicative of table rows in the electronic document 124.

The method 1200 also includes identifying cells of the table based on the vertical mask and the horizontal mask, at 1210. Identifying the cells includes designating a vertical cell boundary based on a number of pixels in a vertical search region that have the first pixel values and designating a horizontal cell boundary based on a number of pixels in a horizontal search region that have the first pixel values. For example, the processor 104 may execute the layout generation algorithm described with respect to the pseudocode 1100 of FIG. 11 to generate the second computer-generated table 1050. The layout generation algorithm may compare edges of the first computer-generated table 1020 to the vertical mask 1030 and the horizontal mask 1040 to identify cells of the table in the electronic document 124.

The method 1200 further includes generating a searchable data structure based on text corresponding to the identified cells of the table, at 1212. For example, referring to FIG. 10G, the processor 104 may populate the cells in the second computer-generated table 1050 based on the text in the electronic document 124 to generate the searchable data structure 130.

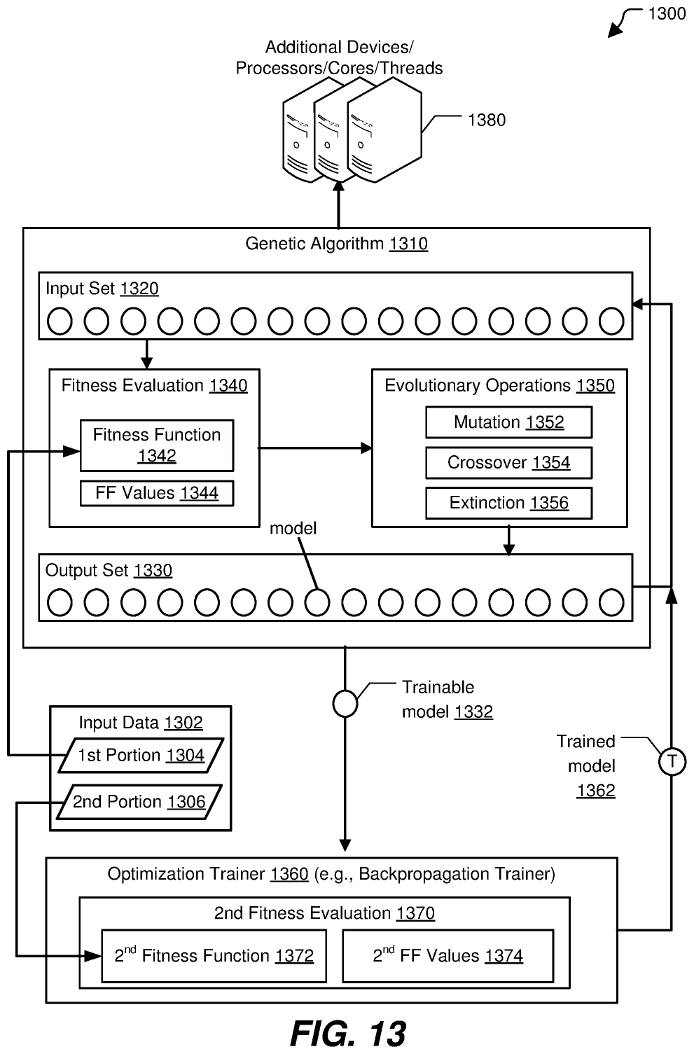

Referring to FIG. 13, a particular illustrative example of a system 1300 executing automated model builder instructions is shown. In a particular implementation, the automated model builder instructions include, are included within, or correspond to the model builder 720 of FIG. 7. The system 1300, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the automated model builder instructions include a genetic algorithm 1310 and an optimization trainer 1360. The optimization trainer 1360 is, for example, a backpropagation trainer, a derivative free optimizer (DFO), an extreme learning machine (ELM), etc. In particular implementations, the genetic algorithm 1310 is executed on a different device, processor (e.g., central processor unit (CPU), graphics processing unit (GPU) or other type of processor), processor core, and/or thread (e.g., hardware or software thread) than the optimization trainer 1360. The genetic algorithm 1310 and the optimization trainer 1360 are executed cooperatively to automatically generate a machine-learning model (e.g., one or more of the machine-learning models 113 of FIG. 1 and referred to herein as “models” for ease of reference) based on the input data 1302 (such as the labeled training data 718 of FIG. 7). The system 1300 performs an automated model building process that enables users, including inexperienced users, to quickly and easily build highly accurate models based on a specified data set.

During configuration of the system 1300, a user specifies the input data 1302. In some implementations, the user can also specify one or more characteristics of models that can be generated. In such implementations, the system 1300 constrains models processed by the genetic algorithm 1310 to those that have the one or more specified characteristics. For example, the specified characteristics can constrain allowed model topologies (e.g., to include no more than a specified number of input nodes or output nodes, no more than a specified number of hidden layers, no recurrent loops, etc.). Constraining the characteristics of the models can reduce the computing resources (e.g., time, memory, processor cycles, etc.) needed to converge to a final model, can reduce the computing resources needed to use the model (e.g., by simplifying the model), or both.

The user can configure aspects of the genetic algorithm 1310 via input to graphical user interfaces (GUIs). For example, the user may provide input to limit a number of epochs that will be executed by the genetic algorithm 1310. Alternatively, the user may specify a time limit indicating an amount of time that the genetic algorithm 1310 has to execute before outputting a final output model, and the genetic algorithm 1310 may determine a number of epochs that will be executed based on the specified time limit. To illustrate, an initial epoch of the genetic algorithm 1310 may be timed (e.g., using a hardware or software timer at the computing device executing the genetic algorithm 1310), and a total number of epochs that are to be executed within the specified time limit may be determined accordingly. As another example, the user may constrain a number of models evaluated in each epoch, for example by constraining the size of an input set 1320 of models and/or an output set 1330 of models.

The genetic algorithm 1310 represents a recursive search process. Consequently, each iteration of the search process (also called an epoch or generation of the genetic algorithm 1310) has an input set 1320 of models (also referred to herein as an input population) and an output set 1330 of models (also referred to herein as an output population). The input set 1320 and the output set 1330 may each include a plurality of models, where each model includes data representative of a machine learning data model. For example, each model may specify a neural network or an autoencoder by at least an architecture, a series of activation functions, and connection weights. The architecture (also referred to herein as a topology) of a model includes a configuration of layers or nodes and connections therebetween. The models may also be specified to include other parameters, including but not limited to bias values/functions and aggregation functions.

For example, each model can be represented by a set of parameters and a set of hyperparameters. In this context, the hyperparameters of a model define the architecture of the model (e.g., the specific arrangement of layers or nodes and connections), and the parameters of the model refer to values that are learned or updated during optimization training of the model. For example, the parameters include or correspond to connection weights and biases.

In a particular implementation, a model is represented as a set of nodes and connections therebetween. In such implementations, the hyperparameters of the model include the data descriptive of each of the nodes, such as an activation function of each node, an aggregation function of each node, and data describing node pairs linked by corresponding connections. The activation function of a node is a step function, sine function, continuous or piecewise linear function, sigmoid function, hyperbolic tangent function, or another type of mathematical function that represents a threshold at which the node is activated. The aggregation function is a mathematical function that combines (e.g., sum, product, etc.) input signals to the node. An output of the aggregation function may be used as input to the activation function.

In another particular implementation, the model is represented on a layer-by-layer basis. For example, the hyperparameters define layers, and each layer includes layer data, such as a layer type and a node count. Examples of layer types include fully connected, long short-term memory (LSTM) layers, gated recurrent units (GRU) layers, and convolutional neural network (CNN) layers. In some implementations, all of the nodes of a particular layer use the same activation function and aggregation function. In such implementations, specifying the layer type and node count fully may describe the hyperparameters of each layer. In other implementations, the activation function and aggregation function of the nodes of a particular layer can be specified independently of the layer type of the layer. For example, in such implementations, one fully connected layer can use a sigmoid activation function and another fully connected layer (having the same layer type as the first fully connected layer) can use a tanh activation function. In such implementations, the hyperparameters of a layer include layer type, node count, activation function, and aggregation function. Further, a complete autoencoder is specified by specifying an order of layers and the hyperparameters of each layer of the autoencoder.

In a particular aspect, the genetic algorithm 1310 may be configured to perform speciation. For example, the genetic algorithm 1310 may be configured to cluster the models of the input set 1320 into species based on “genetic distance” between the models. The genetic distance between two models may be measured or evaluated based on differences in nodes, activation functions, aggregation functions, connections, connection weights, layers, layer types, latent-space layers, encoders, decoders, etc. of the two models. In an illustrative example, the genetic algorithm 1310 may be configured to serialize a model into a bit string. In this example, the genetic distance between models may be represented by the number of differing bits in the bit strings corresponding to the models. The bit strings corresponding to models may be referred to as “encodings” of the models.

After configuration, the genetic algorithm 1310 may begin execution based on the input data 1302. Parameters of the genetic algorithm 1310 may include but are not limited to, mutation parameter(s), a maximum number of epochs the genetic algorithm 1310 will be executed, a termination condition (e.g., a threshold fitness value that results in termination of the genetic algorithm 1310 even if the maximum number of generations has not been reached), whether parallelization of model testing or fitness evaluation is enabled, whether to evolve a feedforward or recurrent neural network, etc. As used herein, a “mutation parameter” affects the likelihood of a mutation operation occurring with respect to a candidate neural network, the extent of the mutation operation (e.g., how many bits, bytes, fields, characteristics, etc. change due to the mutation operation), and/or the type of the mutation operation (e.g., whether the mutation changes a node characteristic, a link characteristic, etc.). In some examples, the genetic algorithm 1310 uses a single mutation parameter or set of mutation parameters for all of the models. In such examples, the mutation parameter may impact how often, how much, and/or what types of mutations can happen to any model of the genetic algorithm 1310. In alternative examples, the genetic algorithm 1310 maintains multiple mutation parameters or sets of mutation parameters, such as for individual or groups of models or species. In particular aspects, the mutation parameter(s) affect crossover and/or mutation operations, which are further described below.

For an initial epoch of the genetic algorithm 1310, the topologies of the models in the input set 1320 may be randomly or pseudo-randomly generated within constraints specified by the configuration settings or by one or more architectural parameters. Accordingly, the input set 1320 may include models with multiple distinct topologies. For example, a first model of the initial epoch may have a first topology, including a first number of input nodes associated with a first set of data parameters, a first number of hidden layers including a first number and arrangement of hidden nodes, one or more output nodes, and a first set of interconnections between the nodes. In this example, a second model of the initial epoch may have a second topology, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes. Further, one or more layers of the first model can be of a different layer type that one or more layers of the second model. For example, the first model can be a feedforward model, with no recurrent layers; whereas the second model can include one or more recurrent layers.

The genetic algorithm 1310 may automatically assign an activation function, an aggregation function, a bias, connection weights, etc. to each model of the input set 1320 for the initial epoch. In some aspects, the connection weights are initially assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes or layers of a model may have different types of activation functions. Aggregation functions may similarly be randomly or pseudo-randomly assigned for the models in the input set 1320 of the initial epoch. Thus, the models of the input set 1320 of the initial epoch may have different topologies (which may include different input nodes corresponding to different input data fields if the data set includes many data fields) and different connection weights. Further, the models of the input set 1320 of the initial epoch may include nodes having different activation functions, aggregation functions, and/or bias values/functions.

During execution, the genetic algorithm 1310 performs fitness evaluation 1340 and evolutionary operations 1350 on the input set 1320. In this context, fitness evaluation 1340 includes evaluating each model of the input set 1320 using a fitness function 1342 to determine a fitness function value 1344 (“FF values” in FIG. 13) for each model of the input set 1320. The fitness function values 1344 are used to select one or more models of the input set 1320 to modify using one or more of the evolutionary operations 1350. In FIG. 13, the evolutionary operations 1350 include mutation operations 1352, crossover operations 1354, and extinction operations 1356, each of which is described further below.

During the fitness evaluation 1340, each model of the input set 1320 is tested based on the input data 1302 to determine a corresponding fitness function value 1344. For example, a first portion 1304 of the input data 1302 may be provided as input data to each model, which processes the input data (according to the network topology, connection weights, activation function, etc., of the respective model) to generate output data. The output data of each model is evaluated using the fitness function 1342 and the first portion 1304 of the input data 1302 to determine how well the model modeled the input data 1302. In some examples, fitness of a model is based on reliability of the model, performance of the model, complexity (or sparsity) of the model, size of the latent space, or a combination thereof.

In a particular aspect, fitness evaluation 1340 of the models of the input set 1320 is performed in parallel. To illustrate, the system 1300 may include devices, processors, cores, and/or threads 1380 in addition to those that execute the genetic algorithm 1310 and the optimization trainer 1360. These additional devices, processors, cores, and/or threads 1380 can perform the fitness evaluation 1340 of the models of the input set 1320 in parallel based on a first portion 1304 of the input data 1302 and may provide the resulting fitness function values 1344 to the genetic algorithm 1310.

The mutation operation 1352 and the crossover operation 1354 are highly stochastic under certain constraints and a defined set of probabilities optimized for model building, which produces reproduction operations that can be used to generate the output set 1330, or at least a portion thereof, from the input set 1320. In a particular implementation, the genetic algorithm 1310 utilizes intra-species reproduction (as opposed to inter-species reproduction) in generating the output set 1330. In other implementations, inter-species reproduction may be used in addition to or instead of intra-species reproduction to generate the output set 1330. Generally, the mutation operation 1352 and the crossover operation 1354 are selectively performed on models that are more fit (e.g., have higher fitness function values 1344, fitness function values 1344 that have changed significantly between two or more epochs, or both).

The extinction operation 1356 uses a stagnation criterion to determine when a species should be omitted from a population used as the input set 1320 for a subsequent epoch of the genetic algorithm 1310. Generally, the extinction operation 1356 is selectively performed on models that are satisfy a stagnation criteria, such as modes that have low fitness function values 1344, fitness function values 1344 that have changed little over several epochs, or both.

In accordance with the present disclosure, cooperative execution of the genetic algorithm 1310 and the optimization trainer 1360 is used to arrive at a solution faster than would occur by using a genetic algorithm 1310 alone or an optimization trainer 1360 alone. Additionally, in some implementations, the genetic algorithm 1310 and the optimization trainer 1360 evaluate fitness using different data sets, with different measures of fitness, or both, which can improve fidelity of operation of the final model. To facilitate cooperative execution, a model (referred to herein as a trainable model 1332 in FIG. 13) is occasionally sent from the genetic algorithm 1310 to the optimization trainer 1360 for training. In a particular implementation, the trainable model 1332 is based on crossing over and/or mutating the fittest models (based on the fitness evaluation 1340) of the input set 1320. In such implementations, the trainable model 1332 is not merely a selected model of the input set 1320; rather, the trainable model 1332 represents a potential advancement with respect to the fittest models of the input set 1320.

The optimization trainer 1360 uses a second portion 1306 of the input data 1302 to train the connection weights and biases of the trainable model 1332, thereby generating a trained model 1362. The optimization trainer 1360 does not modify the architecture of the trainable model 1332.

During optimization, the optimization trainer 1360 provides a second portion 1306 of the input data 1302 to the trainable model 1332 to generate output data. The optimization trainer 1360 performs a second fitness evaluation 1370 by comparing the data input to the trainable model 1332 to the output data from the trainable model 1332 to determine a second fitness function value 1374 based on a second fitness function 1372. The second fitness function 1372 is the same as the first fitness function 1342 in some implementations and is different from the first fitness function 1342 in other implementations. In some implementations, the optimization trainer 1360 or portions thereof is executed on a different device, processor, core, and/or thread than the genetic algorithm 1310. In such implementations, the genetic algorithm 1310 can continue executing additional epoch(s) while the connection weights of the trainable model 1332 are being trained by the optimization trainer 1360. When training is complete, the trained model 1362 is input back into (a subsequent epoch of) the genetic algorithm 1310, so that the positively reinforced “genetic traits” of the trained model 1362 are available to be inherited by other models in the genetic algorithm 1310.

In implementations in which the genetic algorithm 1310 employs speciation, a species ID of each of the models may be set to a value corresponding to the species that the model has been clustered into. A species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 1310 may maintain a data structure that tracks the fitness of each species across multiple epochs. Based on the species fitness, the genetic algorithm 1310 may identify the “fittest” species, which may also be referred to as “elite species.” Different numbers of elite species may be identified in different embodiments.

In a particular aspect, the genetic algorithm 1310 uses species fitness to determine if a species has become stagnant and is therefore to become extinct. As an illustrative non-limiting example, the stagnation criterion of the extinction operation 1356 may indicate that a species has become stagnant if the fitness of that species remains within a particular range (e.g., +/−5%) for a particular number (e.g., 5) of epochs. If a species satisfies a stagnation criterion, the species and all underlying models may be removed from subsequent epochs of the genetic algorithm 1310.

In some implementations, the fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.”

The output set 1330 of the epoch is generated based on the input set 1320 and the evolutionary operation 1350. In the illustrated example, the output set 1330 includes the same number of models as the input set 1320. In some implementations, the output set 1330 includes each of the “overall elite” models and each of the “elite member” models. Propagating the “overall elite” and “elite member” models to the next epoch may preserve the “genetic traits” resulted in caused such models being assigned high fitness values.

The rest of the output set 1330 may be filled out by random reproduction using the crossover operation 1354 and/or the mutation operation 1352. After the output set 1330 is generated, the output set 1330 may be provided as the input set 1320 for the next epoch of the genetic algorithm 1310.

After one or more epochs of the genetic algorithm 1310 and one or more rounds of optimization by the optimization trainer 1360, the system 1300 selects a particular model or a set of model as the final model (e.g., one of the machine-learning models 113). For example, the final model may be selected based on the fitness function values 1344, 1374. For example, a model or set of models having the highest fitness function value 1344 or 1374 may be selected as the final model. When multiple models are selected (e.g., an entire species is selected), an ensembler can be generated (e.g., based on heuristic rules or using the genetic algorithm 1310) to aggregate the multiple models. In some implementations, the final model can be provided to the optimization trainer 1360 for one or more rounds of optimization after the final model is selected. Subsequently, the final model can be output for use with respect to other data (e.g., real-time data).

The systems and methods illustrated herein may be described in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as, but not limited to, C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may take the form of or include a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the actions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Particular aspects of the disclosure are described below in a first set of interrelated clauses:

According to Clause 1, a method of generating a searchable representation of an electronic document includes obtaining an electronic document specifying a graphical layout of content items, the content items including at least text; determining pixel data representing the graphical layout of the content items; providing input data based, at least in part, on the pixel data to a document parsing model that is trained to detect functional regions within the graphical layout based on the input data, to assign boundaries to the functional regions based on the input data, and to assign a category label to each functional region that is detected; matching portions of the text to corresponding functional regions based on the boundaries assigned to the functional regions and locations associated with the portions of the text; and storing data representing the content items, the functional regions, and the category labels in a searchable data structure.

Clause 2 includes the method of Clause 1 wherein the pixel data defines a plurality of display elements to render a display of the electronic document and each display element encodes at least one color bit representing a display color of the display element.

Clause 3 includes the method of Clause 1 or the method of Clause 2 wherein the searchable data structure comprises a tree structure having a plurality of leaf nodes, each leaf node associated with a corresponding branch node, and wherein the content items are assigned to nodes of the tree structure such that a hierarchy of the functional regions is represented in the tree structure.

Clause 4 includes the method of any of Clauses 1 to 3 and further comprises, after storing the data in the searchable data structure, generating one or more search heuristics based on the content items, the functional regions, the category labels, or a combination thereof; and storing the one or more search heuristics for use when searching the searchable data structure.

Clause 5 includes the method of Clause 4 and further comprises, after storing the one or more search heuristics, receiving a search query related to a document corpus that includes the electronic document; accessing the one or more search heuristics; generating an augmented search query based on the search query and the one or more search heuristics; and searching the document corpus using the augmented search query.

Clause 6 includes the method of any of Clauses 1 to 5 wherein the functional regions detected by the document parsing model include two or more of a page header, a page footer, a section heading, a paragraph, a table, an image, a footnote, or a list.

Clause 7 includes the method of any of Clauses 1 to 6 and further comprises for a particular functional region labeled as a table, estimating column boundaries and row boundaries based on the input data associated with the particular functional region; determining a column heading of a column based on the text associated with the particular functional region; storing a portion of the text associated with the particular functional region in a first data element of the searchable data structure; and storing the column heading of the column in a second data element, wherein the first data element is subordinate to the second data element in the searchable data structure.

Clause 8 includes the method of Clause 7 wherein determining the column heading includes using a natural-language processing model to determine a semantic group represented by text of the column.

Clause 9 includes the method of any of Clauses 1 to 8 wherein the data specifying the graphical layout of the content items indicates font characteristics for particular text associated with a particular functional region, and wherein the document parsing model assigns a particular category label to the particular functional region based on at least one of the font characteristics of the particular text or a change of the font characteristics between the particular functional region and an adjacent functional region.

Clause 10 includes the method of any of Clauses 1 to 9 wherein the data specifying the graphical layout of the content items indicates character spacing in particular text associated with a particular functional region, and wherein the document parsing model assigns a particular category label to the particular functional region based on at least one of the character spacing of the particular text or a change of the character spacing between the particular functional region and an adjacent functional region.

Clause 11 includes the method of any of Clauses 1 to 10 wherein the data specifying the graphical layout of the content items indicates a background color associated with a particular functional region, and wherein the document parsing model assigns a particular category label to the particular functional region based on at least one of the background color or a change in background color between the particular functional region and an adjacent functional region.

Clause 12 includes the method of any of Clauses 1 to 11 wherein the text includes one or more special characters, and wherein the document parsing model assigns a particular category label to a particular functional region based on a determination that the one or more special characters are present in the particular functional region.

Clause 13 includes the method of any of Clauses 1 to 12 wherein the document parsing model is trained to assign a first category label to a particular functional region based on a probabilistic analysis of the pixel data associated with the particular functional region.

Clause 14 includes the method of any of Clauses 1 to 13 wherein the input data is further based on the text, and wherein the document parsing model is trained to assign a particular category label to a particular functional region further based on a semantic analysis of text associated with the particular functional region.

Clause 15 includes the method of any of Clauses 1 to 13 wherein the searchable data structure has a smaller in-memory footprint than the electronic document.

Clause 16 includes the method of any of Clauses 1 to 15 and further comprises determining a topology of the searchable data structure based on an arrangement of information in the electronic document.

Clause 17 includes the method of any of Clauses 1 to 16 wherein the document parsing model is trained using labeled training data based on a corpus of electronic documents, each electronic document of the corpus including a plurality of identified functional regions and a respective category label for each of the identified functional regions.

According to Clause 18, a system comprises a memory storing instructions; and a processor configured to execute the instructions to perform operations. The operations include obtaining an electronic document that includes data specifying a graphical layout of content items, the content items including at least text; determining pixel data representing the graphical layout of the content items; providing input data based, at least in part, on the pixel data to a document parsing model that is trained to detect functional regions within the graphical layout based on the input data, to assign boundaries to the functional regions based on the input data, and to assign a category label to each functional region that is detected; matching portions of the text to corresponding functional regions based on the boundaries assigned to the functional regions and locations associated with the text; and storing a searchable data structure representing the content items, the functional regions, and the category labels.

Clause 19 includes the system of Clause 18 wherein the functional regions include two or more of a page header, a page footer, a section heading, a paragraph, a table, an image, a footnote, or a list.

Clause 20 includes the system of Clause 18 or Clause 19 wherein, for a particular functional region labeled as a table, the operations include estimating column boundaries and row boundaries based on the input data associated with the particular functional region; determining a column heading of a column based on the text associated within the particular functional region; storing a portion of the text associated within the particular functional region in a first data element of the searchable data structure; and storing the column heading of the column in a second data element, wherein the first data element is subordinate to the second data element in the searchable data structure.

Clause 21 includes the system of Clause 20 wherein determining the column heading includes using a natural-language processing model to determine a semantic group represented by text of the column.

Clause 22 includes the system of any of Clauses 18 to 21 wherein the data specifying the graphical layout of the content items indicates font characteristics for particular text associated with a particular functional region, and the document parsing model is configured to assign a particular category label to the particular functional region based on at least one of the font characteristics of the particular text or a change of the font characteristics between the particular functional region and an adjacent functional region.

Clause 23 includes the system of any of Clauses 18 to 22 wherein the data specifying the graphical layout of the content items indicates character spacing in particular text associated with a particular functional region, and the document parsing model is configured to assign a particular category label to the particular functional region based on at least one of the character spacing of the particular text or a change of the character spacing between the particular functional region and an adjacent functional region.

Clause 24 includes the system of any of Clauses 18 to 23 wherein the data specifying the graphical layout of the content items indicates a background color associated with a particular functional region, wherein and the document parsing model is configured to assign a particular category label to the particular functional region based on at least one of the background color or a change in background color between the particular functional region and an adjacent functional region.

Clause 25 includes the system of any of Clauses 18 to 24 wherein the text includes one or more special characters and the document parsing model is configured to assign a particular category label to a particular functional region based on a determination that the one or more special characters are present in the particular functional region.

Clause 26 includes the system of any of Clauses 18 to 25 wherein the document parsing model is trained to assign a first category label to a particular functional region based on probabilistic analysis of the pixel data associated with the particular functional region.

Clause 27 includes the system of any of Clauses 18 to 26 wherein the input data is further based on the text and the document parsing model is trained to assign a particular category label to a particular functional region further based on a semantic analysis of text associated with the particular functional region.

Clause 28 includes the system of any of Clauses 18 to 27 wherein the searchable data structure has a smaller in-memory footprint than the electronic document.

Clause 29 includes the system of Clause 28 wherein the searchable data structure comprises a tree structure having a plurality of leaf nodes, each leaf node associated with a corresponding branch node, and wherein the content items are assigned to nodes of the tree structure such that a hierarchy of the functional regions is represented in the tree structure.

Clause 30 includes the system of any of Clauses 18 to 29 wherein the operations further comprise determining a topology of the searchable data structure based on an arrangement of information in the electronic document.

According to Clause 31, a non-transitory computer-readable medium stores instructions that are executable by a processor to cause the processor to perform operations comprising obtaining an electronic document that includes data specifying a graphical layout of content items, the content items including at least text; determining pixel data representing the graphical layout of the content items; providing input data based, at least in part, on the pixel data to a document parsing model that is trained to detect functional regions within the graphical layout based on the input data, to assign boundaries to the functional regions based on the input data, and to assign a category label to each functional region that is detected; matching portions of the text to corresponding functional regions based on the boundaries assigned to the functional regions and locations associated with the text; and storing a searchable data structure representing the content items, the functional regions, and the category labels.

According to Clause 32, a method of generating a searchable representation of an electronic document includes obtaining an electronic document specifying a graphical layout of content items, the content items including at least text in a table; selecting masking rules based a document type of the electronic document, based on user responses to prompts, or based on the document type and the user responses; generating a vertical mask based on the masking rules, where the vertical mask indicates estimated locations of vertical boundaries of table columns of the table, and wherein generating the vertical mask includes assigning a first pixel value to each pixel that corresponds to an estimated location of one of the vertical boundaries; generating a horizontal mask based on the masking rules, where the horizontal mask indicates estimated locations of horizontal boundaries of table rows of the table, and wherein generating the horizontal mask includes assigning the first pixel value to each pixel that corresponds to an estimated location of one of the horizontal boundaries; identifying cells of the table based on the vertical mask and the horizontal mask, where identifying the cells includes designating a vertical cell boundary based on a number of pixels in a vertical search region that have the first pixel values and designating a horizontal cell boundary based on a number of pixels in a horizontal search region that have the first pixel values; and generating a searchable data structure based on text corresponding to the identified cells of the table.

According to Clause 33, a system comprises a memory storing instructions; and a processor configured to execute the instructions to perform operations. The operations include obtaining an electronic document specifying a graphical layout of content items, the content items including at least text in a table; selecting masking rules based a document type of the electronic document, based on user responses to prompts, or based on the document type and the user responses; generating a vertical mask based on the masking rules, where the vertical mask indicates estimated locations of vertical boundaries of table columns of the table, and wherein generating the vertical mask includes assigning a first pixel value to each pixel that corresponds to an estimated location of one of the vertical boundaries; generating a horizontal mask based on the masking rules, where the horizontal mask indicates estimated locations of horizontal boundaries of table rows of the table, and wherein generating the horizontal mask includes assigning the first pixel value to each pixel that corresponds to an estimated location of one of the horizontal boundaries; identifying cells of the table based on the vertical mask and the horizontal mask, where identifying the cells includes designating a vertical cell boundary based on a number of pixels in a vertical search region that have the first pixel values and designating a horizontal cell boundary based on a number of pixels in a horizontal search region that have the first pixel values; and generating a searchable data structure based on text corresponding to the identified cells of the table.

According to Clause 34, a non-transitory computer-readable medium stores instructions that are executable by a processor to cause the processor to perform operations comprising obtaining an electronic document specifying a graphical layout of content items, the content items including at least text in a table; selecting masking rules based a document type of the electronic document, based on user responses to prompts, or based on the document type and the user responses; generating a vertical mask based on the masking rules, where the vertical mask indicates estimated locations of vertical boundaries of table columns of the table, and wherein generating the vertical mask includes assigning a first pixel value to each pixel that corresponds to an estimated location of one of the vertical boundaries; generating a horizontal mask based on the masking rules, where the horizontal mask indicates estimated locations of horizontal boundaries of table rows of the table, and wherein generating the horizontal mask includes assigning the first pixel value to each pixel that corresponds to an estimated location of one of the horizontal boundaries; identifying cells of the table based on the vertical mask and the horizontal mask, where identifying the cells includes designating a vertical cell boundary based on a number of pixels in a vertical search region that have the first pixel values and designating a horizontal cell boundary based on a number of pixels in a horizontal search region that have the first pixel values; and generating a searchable data structure based on text corresponding to the identified cells of the table.

Changes and modifications may be made to the disclosed embodiments without departing from the scope of the present disclosure. These and other changes or modifications are intended to be included within the scope of the present disclosure, as expressed in the following claims.

What is claimed is:

1. A method of generating a searchable representation of an electronic document, the method comprising:
obtaining an electronic document specifying a graphical layout of content items, the content items including at least text;
determining pixel data representing the graphical layout of the content items;
providing input data based, at least in part, on the pixel data to a document parsing model that is trained to:
detect functional regions within the graphical layout based on the input data;
assign boundaries to the functional regions based on the input data; and
assign a category label to each functional region that is detected;
matching portions of the text to corresponding functional regions based on the boundaries assigned to the functional regions and locations associated with the portions of the text; and
storing data representing the content items, the functional regions, and the category labels in a searchable data structure.

2. The method of claim 1, wherein the pixel data defines a plurality of display elements to render a display of the electronic document and each display element encodes at least one color bit representing a display color of the display element.

3. The method of claim 1, wherein the searchable data structure comprises a tree structure having a plurality of leaf nodes, each leaf node associated with a corresponding branch node, and wherein the content items are assigned to nodes of the tree structure such that a hierarchy of the functional regions is represented in the tree structure.

4. The method of claim 1, further comprising, after storing the data in the searchable data structure:
generating one or more search heuristics based on the content items, the functional regions, the category labels, or a combination thereof; and
storing the one or more search heuristics for use when searching the searchable data structure.

5. The method of claim 4, further comprising, after storing the one or more search heuristics:
receiving a search query related to a document corpus that includes the electronic document;
accessing the one or more search heuristics;
generating an augmented search query based on the search query and the one or more search heuristics; and
searching the document corpus using the augmented search query.

6. The method of claim 1, wherein the functional regions detected by the document parsing model include two or more of a page header, a page footer, a section heading, a paragraph, a table, an image, a footnote, or a list.

7. The method of claim 1, further comprising for a particular functional region labeled as a table:
estimating column boundaries and row boundaries based on the input data associated with the particular functional region;
determining a column heading of a column based on the text associated within the particular functional region;
storing a portion of the text associated within the particular functional region in a first data element of the searchable data structure; and
storing the column heading of the column in a second data element, wherein the first data element is subordinate to the second data element in the searchable data structure.

8. The method of claim 7, wherein determining the column heading includes using a natural-language processing model to determine a semantic group represented by text of the column.

9. The method of claim 1, wherein the data specifying the graphical layout of the content items indicates font characteristics for particular text associated with a particular functional region, and wherein the document parsing model assigns a particular category label to the particular functional region based on at least one of the font characteristics of the particular text or a change of the font characteristics between the particular functional region and an adjacent functional region.

10. The method of claim 1, wherein the data specifying the graphical layout of the content items indicates character spacing in particular text associated with a particular functional region, and wherein the document parsing model assigns a particular category label to the particular functional region based on at least one of the character spacing of the particular text or a change of the character spacing between the particular functional region and an adjacent functional region.

11. The method of claim 1, wherein the data specifying the graphical layout of the content items indicates a background color associated with a particular functional region, and wherein the document parsing model assigns a particular category label to the particular functional region based on at least one of the background color or a change in background color between the particular functional region and an adjacent functional region.

12. The method of claim 1, wherein the text includes one or more special characters, and wherein the document parsing model assigns a particular category label to a particular functional region based on a determination that the one or more special characters are present in the particular function region.

13. The method of claim 1, wherein the document parsing model is trained to assign a first category label to a particular functional region based on a probabilistic analysis of the pixel data associated with the particular functional region.

14. The method of claim 1, wherein the input data is further based on the text, and wherein the document parsing model is trained to assign a particular category label to a particular functional region further based on a semantic analysis of text associated with the particular functional region.

15. The method of claim 1, further comprising determining a topology of the searchable data structure based on an arrangement of information in the electronic document.

16. The method of claim 1, wherein the document parsing model is trained using labeled training data based on a corpus of electronic documents, each electronic document of the corpus including a plurality of identified functional regions and a respective category label for each of the identified function regions.

17. A system comprising:
a memory storing instructions; and
a processor configured to execute the instructions to perform operations including:
obtaining an electronic document that includes data specifying a graphical layout of content items, the content items including at least text;
determining pixel data representing the graphical layout of the content items;
providing input data based, at least in part, on the pixel data to a document parsing model that is trained to:
detect functional regions within the graphical layout based on the input data;
assign boundaries to the functional regions based on the input data; and
assign a category label to each functional region that is detected;
matching portions of the text to corresponding functional regions based on the boundaries assigned to the functional regions and locations associated with the text; and
storing a searchable data structure representing the content items, the functional regions, and the category labels.

18. The system of claim 17, wherein the searchable data structure has a smaller in-memory footprint than the electronic document.

19. The system of claim 18, wherein the searchable data structure comprises a tree structure having a plurality of leaf nodes, each leaf node associated with a corresponding branch node, and wherein the content items are assigned to nodes of the tree structure such that a hierarchy of the functional regions is represented in the tree structure.

20. A non-transitory computer-readable medium storing instructions that are executable by a processor to cause the processor to perform operations comprising:
obtaining an electronic document that includes data specifying a graphical layout of content items, the content items including at least text;
determining pixel data representing the graphical layout of the content items;
providing input data based, at least in part, on the pixel data to a document parsing model that is trained to:
detect functional regions within the graphical layout based on the input data;
assign boundaries to the functional regions based on the input data; and
assign a category label to each functional region that is detected;
matching portions of the text to corresponding functional regions based on the boundaries assigned to the functional regions and locations associated with the text; and
storing a searchable data structure representing the content items, the functional regions, and the category labels.
